(19) United States
(12) Patent Application Publication
(10) Pub. No.: US 2012/0248782 A1
(43) Pub. Date: Oct. 4, 2012

(54) Flying-magnet-dynamo applied in electrical energy generation from Wind, Marine or Mechanical energy transformation

(76) Inventors: Wayne Douglas Pickette, Champaign, IL (US); Anna Victor Epelbaurn-Pickette, Champaign, IL (US); William Gomez, Oak Lawn, IL (US)

(21) Appl. No.: 13/493,487

(22) Filed: Jun. 11, 2012

Related U.S. Application Data
(66) Substitute for application No. 11/936,761, filed on Nov. 14, 2007, now abandoned.

(51) Int. Cl. F03D 9/00; F03B 13/10; H02K 1/27

(52) U.S. Cl. 290/55; 310/156.56; 290/54

(57) ABSTRACT

The vertical windmill turbine generator is a combination of three distinct previously defined inventions by the same inventor and one new invention. It is designed to take advantage of the increased, wind speed caused by the up welling or downward sliding of winds found at walls, fences, or roofs and similar obstructions. This windmill generator has infinitely adjustable vanes, which allow the windmill to govern its speed or respond easily to very low-speed winds. The design also allows inertia to more readily be taken advantage of. With the included flying-magnet-dynamo, as the generator, the static inertia of the windmill generator is greatly minimized. The electrical output is gathered with low ESR capacitors, then regulated by a switching regulator. Vibration and speed censors detect over-speed and agitated wind situations, allowing the device to protect itself by closing some or all vanes instantly. The rotating components communicate with stationery components by radio.

### CROSS-REFERENCE TO RELATED APPLICATIONS

The Flying-magnet-dynamo was originally specified in application Ser. No. 11/936,761 filed Nov. 14, 2007 the application was inadequate and, therefore, abandoned. New embodiments of the dynamo have expanded its applicability: Three such embodiments are included within this application by the same inventor. The dynamo is imperative all these applications, due to the device's light-weight, hum-less operation and low kinetic energy input requirements to allow the ganging of four or more dynamos per windmill, enhancing the cumulative electrical output of these types of windmill and other generator systems.

The CIP Application 13087138 filed Apr. 14, 2011 by the same inventor included the claim of a CERFITE, an electromagnetic motion part formed from soft ferrite material contained within a ceramic, within this application the CERFITE is reembodied into a light-weight multiphase stepper motor with PCB integrally formed activation coils.

### FEDERALLY SPONSORED RESEARCH

Not Applicable

### SEQUENCE LISTING OR PROGRAM

A programming Flowchart is contained within the Appendix

### BACKGROUND

Many windmill generators are too expensive, noisy and are not self-reliant to protect themselves from wild weather which may damage them beyond functionality. This small-vane windmill is designed to be able to close all its vanes when as wild wind arrives. Vibrational sensors on the base of the unit sense deflections of the mast, allowing the wind force to be judged somewhat accurately. In addition, rotation speed is governed similarly, allowing, some vanes to be closed to decrease the wind acceleration factors, when required. In this windmill there is not any slip ring required, therefore, enhancing reliability of the unit, while eliminating nearly all maintenance and minimizing electrical noise. This vertical windmill has no care of from what direction the wind-force is arriving. This windmill-generator is practically silent and does not present a profile that would be disturbing to neighbors.

### PRIOR ART

Existing windmills are very expensive, require frequent maintenance, are noisy and some even present a danger to wildlife. Horizontal axis windmills require a sail and vertical axis rotation elements to stay aligned with the wind. In addition, these windmills require too much space and require self-directing features to be extremely efficient in almost any kind of wind. This requirement leads to further maintenance and establishes multiple points of failure possible for these systems. In all, these devices are more often not fully operational than fully operational. Existing vertical windmills are generally large and require complicated linkages to the generators, which reduce their efficiency and create more maintenance factors. Existing vertical windmills cannot protect themselves from wild wind forces, which may result in damage to the windmill, linkage and possibly other surrounding structures.

### SUMMARY

The combination of the flying-magnet-dynamo and vertical windmill form a new era in power generation at reduced cost, size and greater reliability to be most amiable to the homeowner and small business user who may place them onto a fence, roof edge or wall edge or on a pole to take the best advantage of available winds. The smart-grid interface and nearly automatic operation allow an ease of installation and usage unheralded today in the wind energy industry. In the different embodiments the structure of the flying-magnet-dynamo remains fixed in-principal, while the rotor design, number of tube segments, tube connectors, rotor magnets, anti-acceleration foam, flying-magnets and overall size may vary. The Windmill for efficiency should remain small. It would serve better to have an army of small windmills shall serve the best, as a great number of them cost much less that any large implementation and all the support necessary. Furthermore, other application forms of the flying-magnet-dynamo are further illustrated within the embodiments of this application.

### DRAWINGS

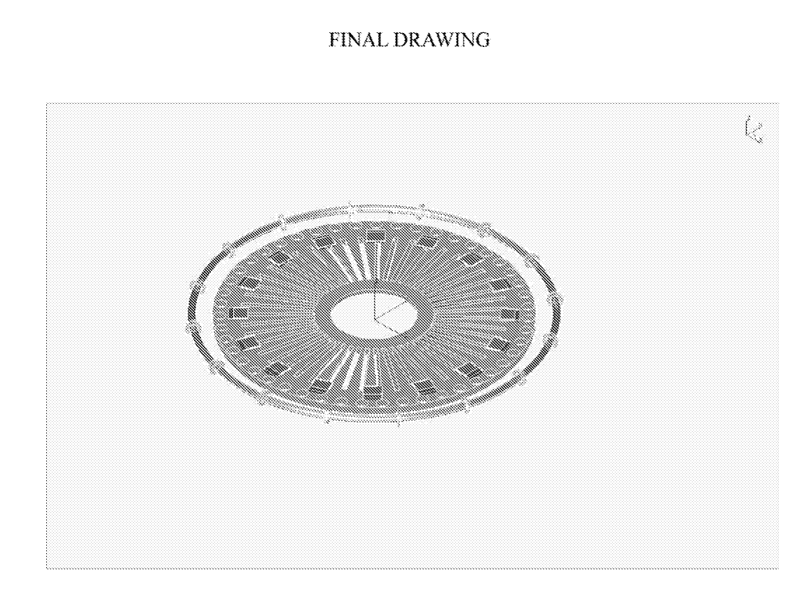

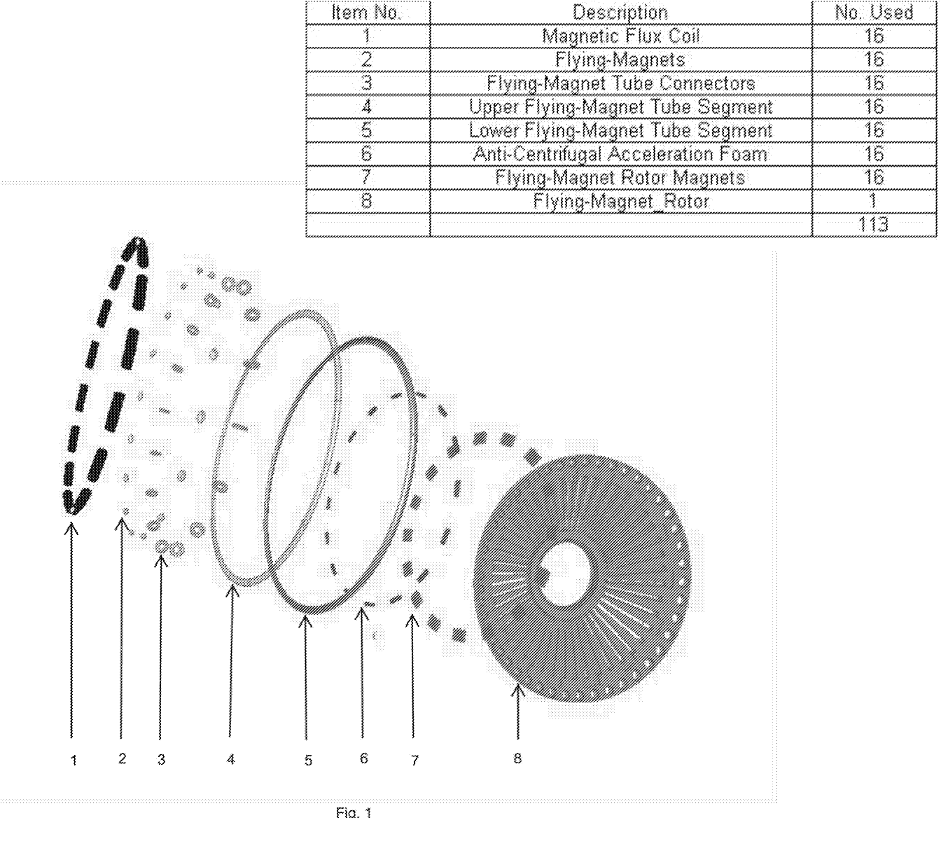

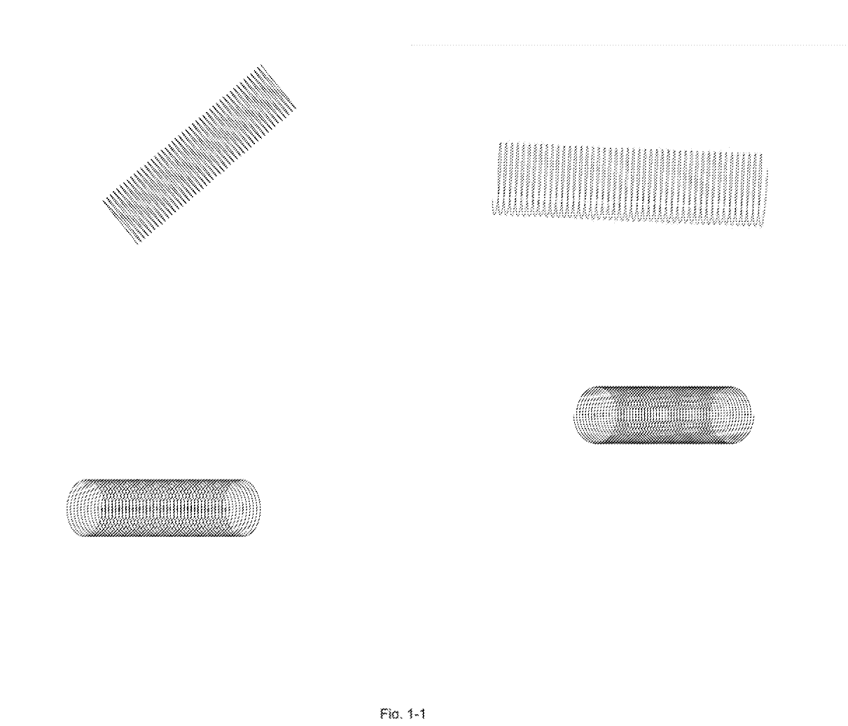

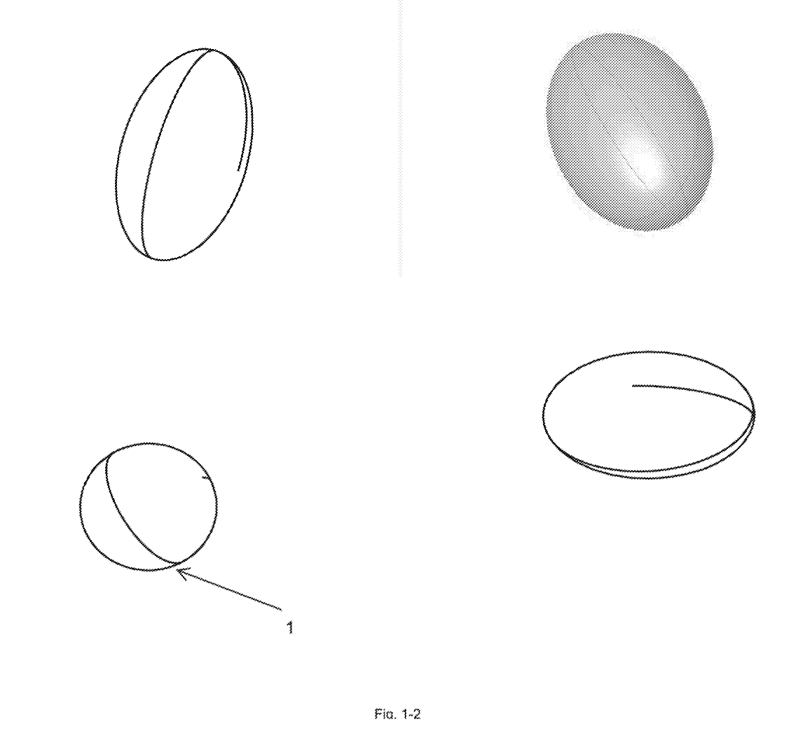

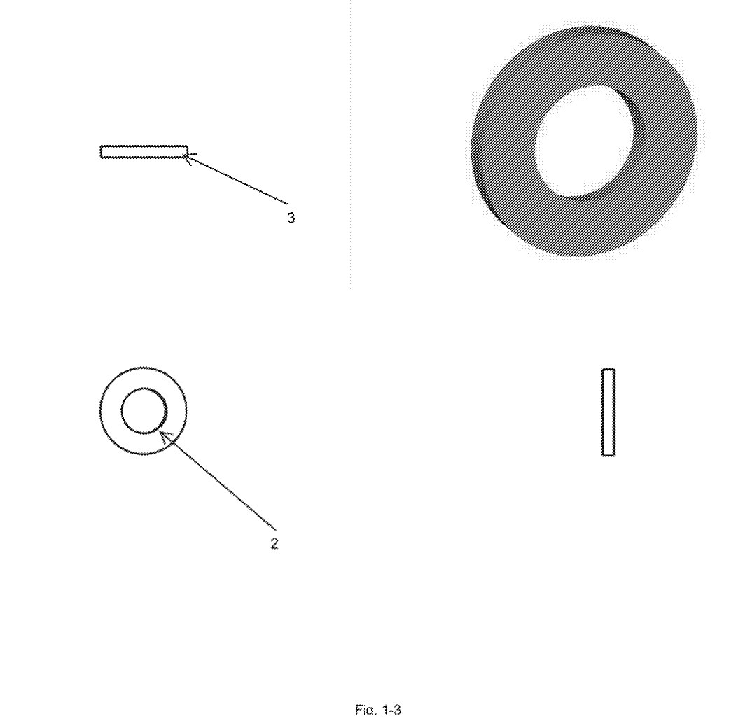

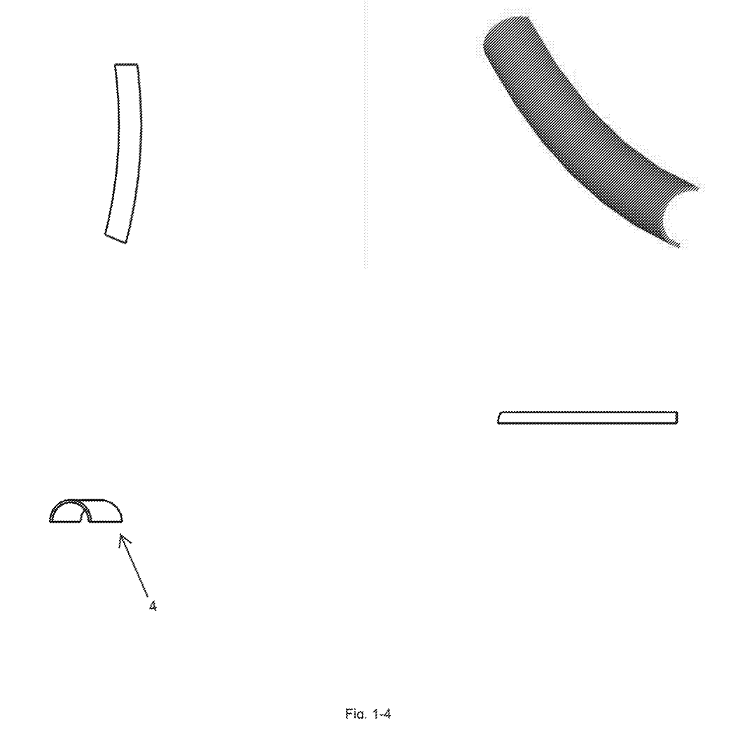

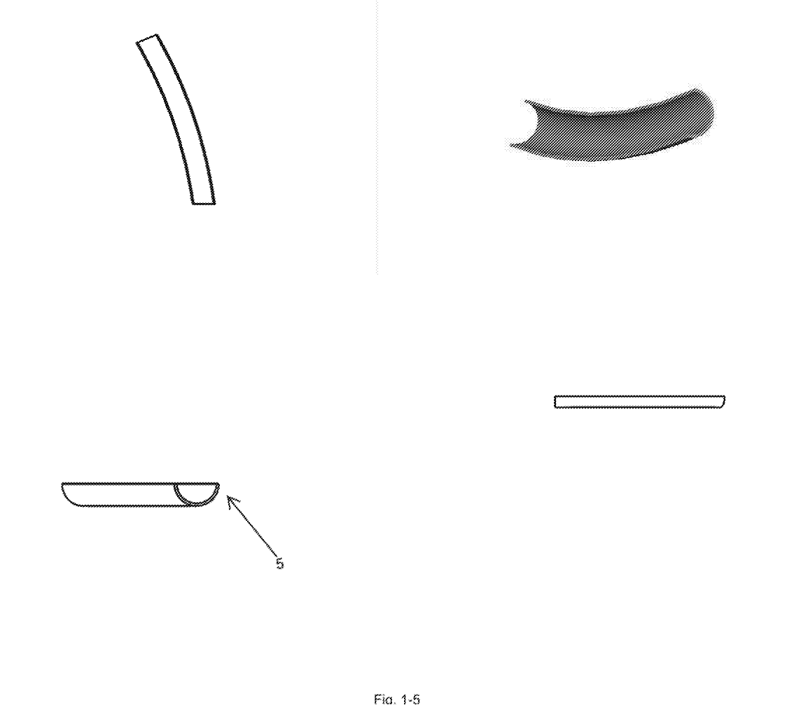

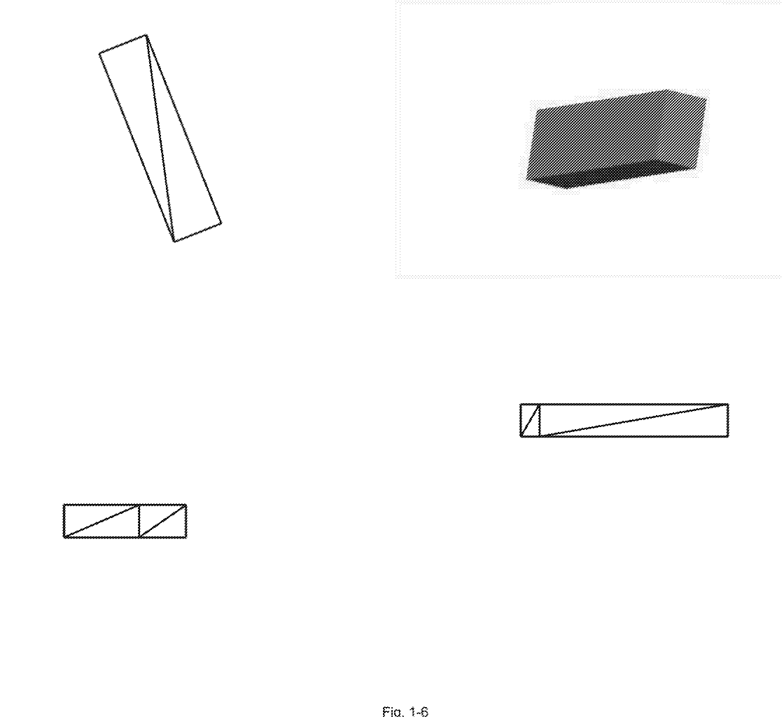

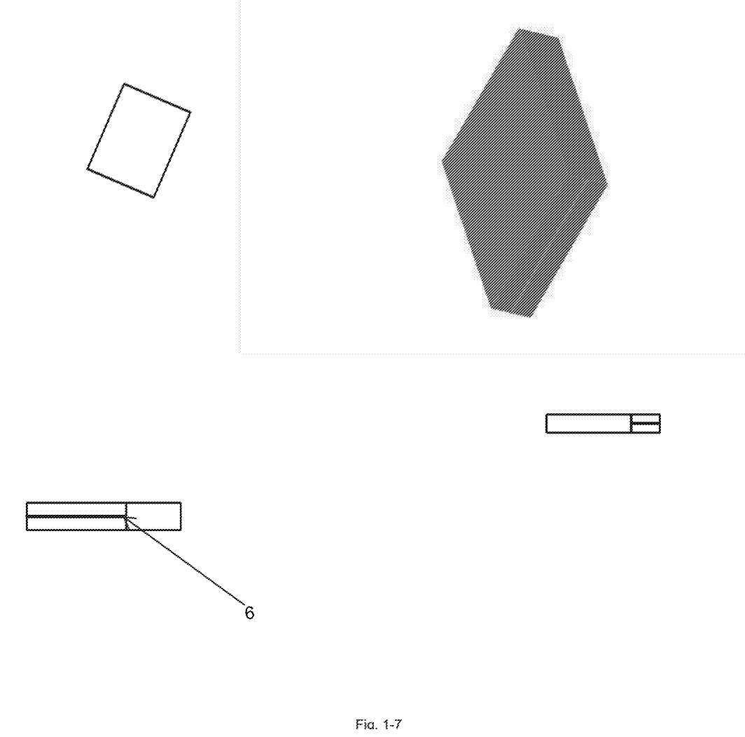

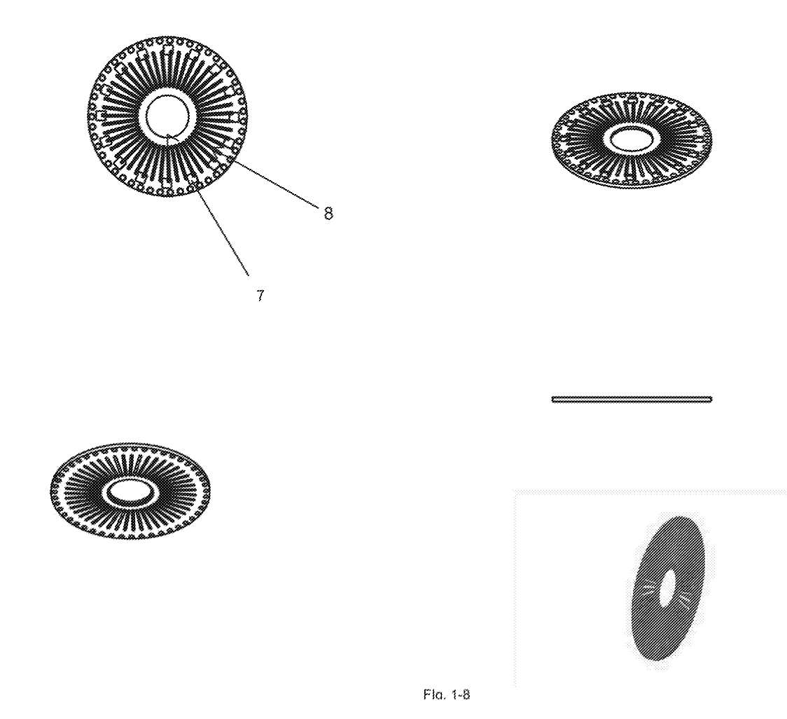

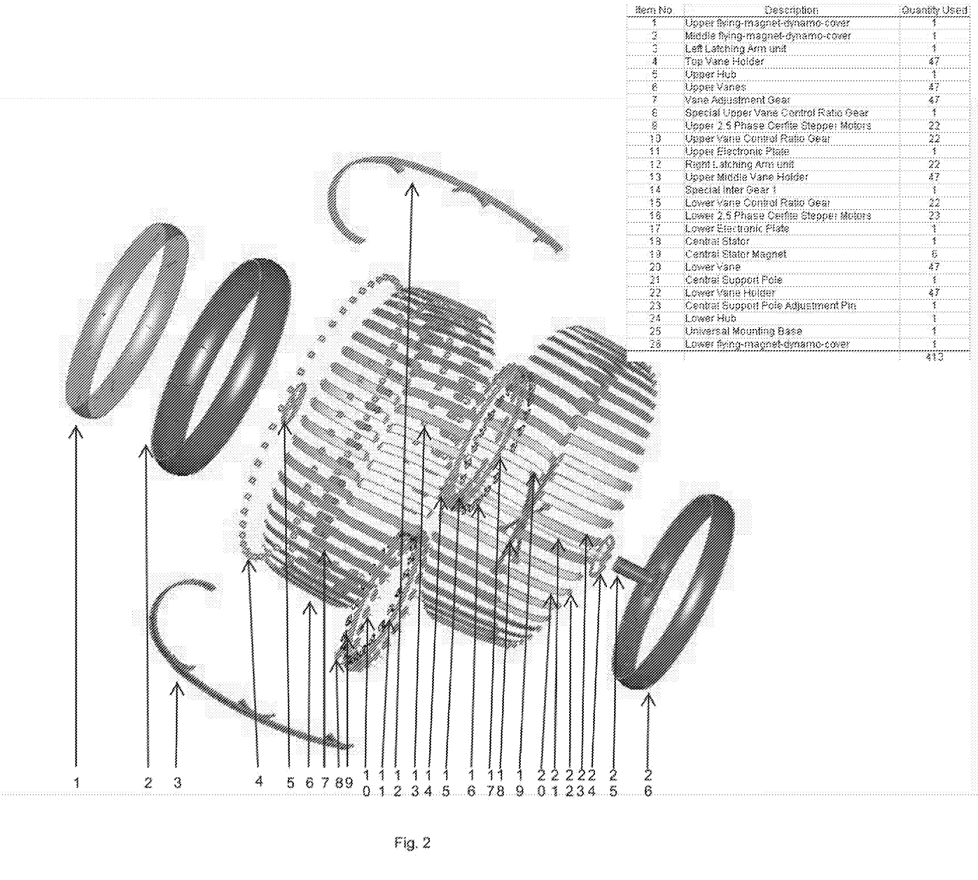

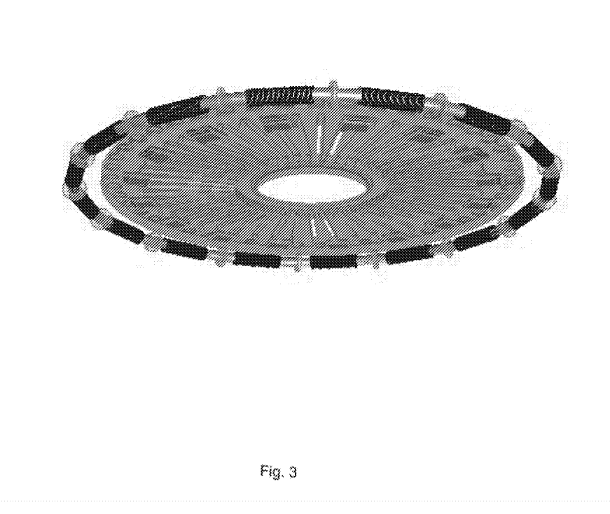

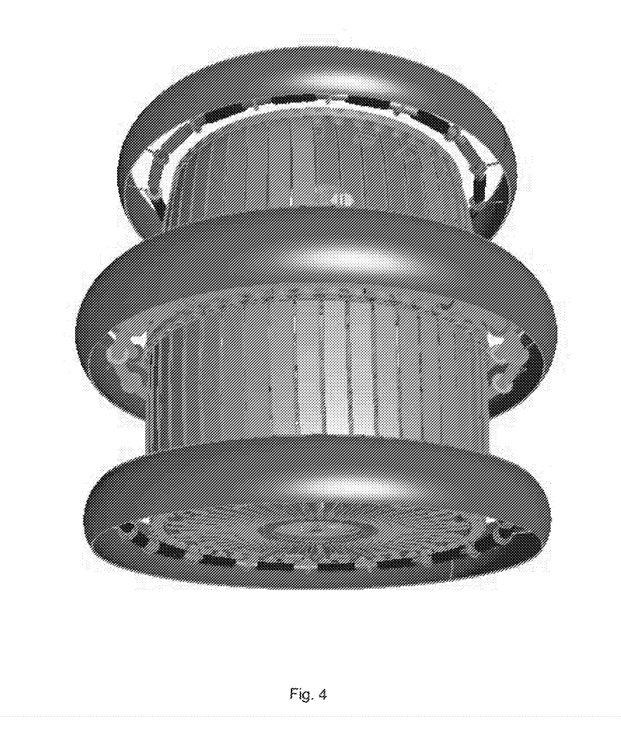

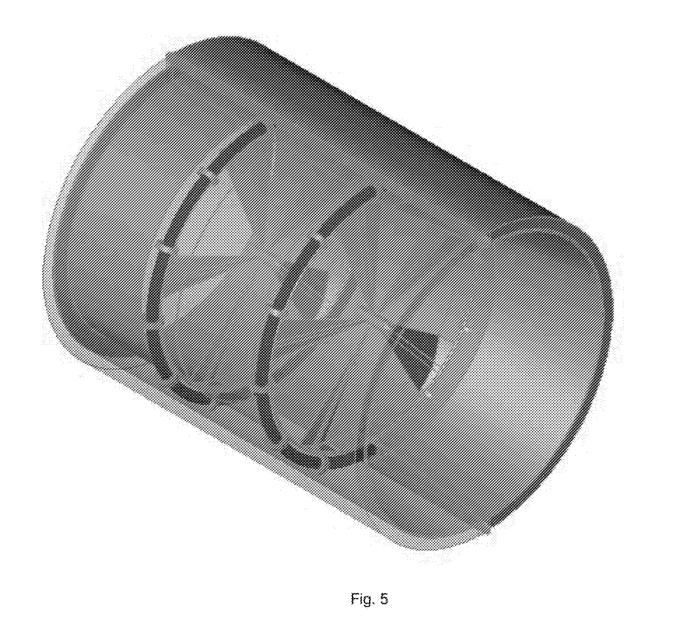

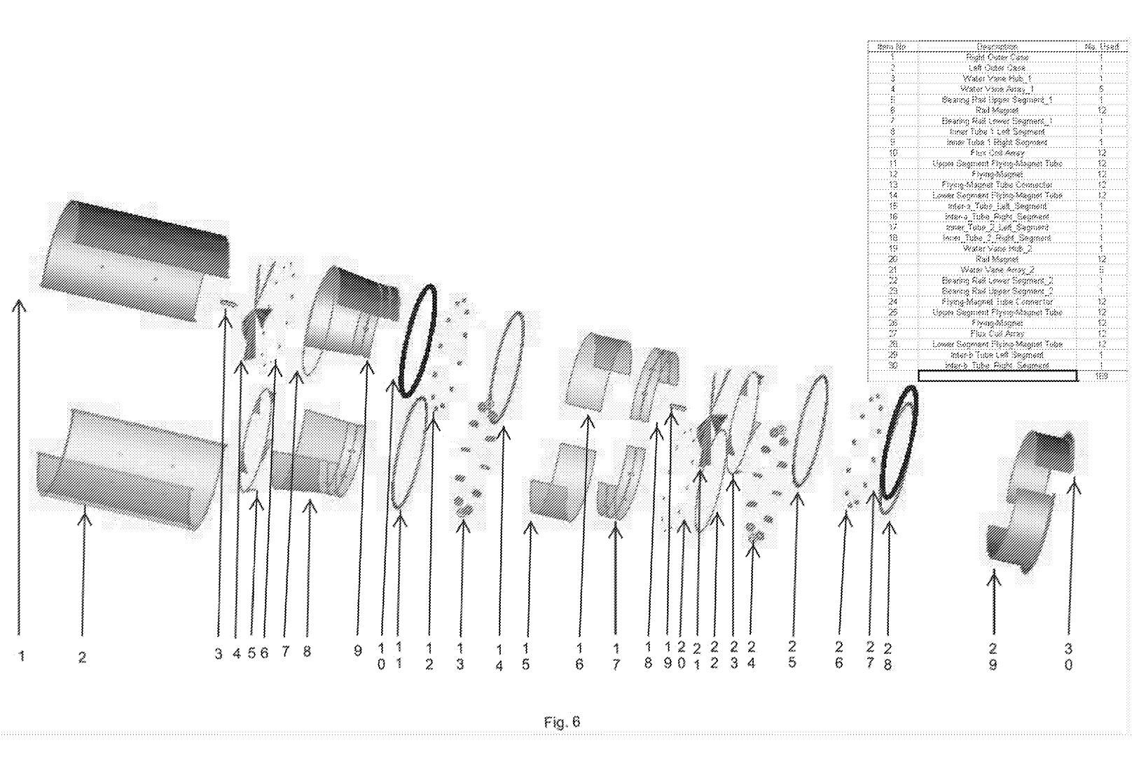

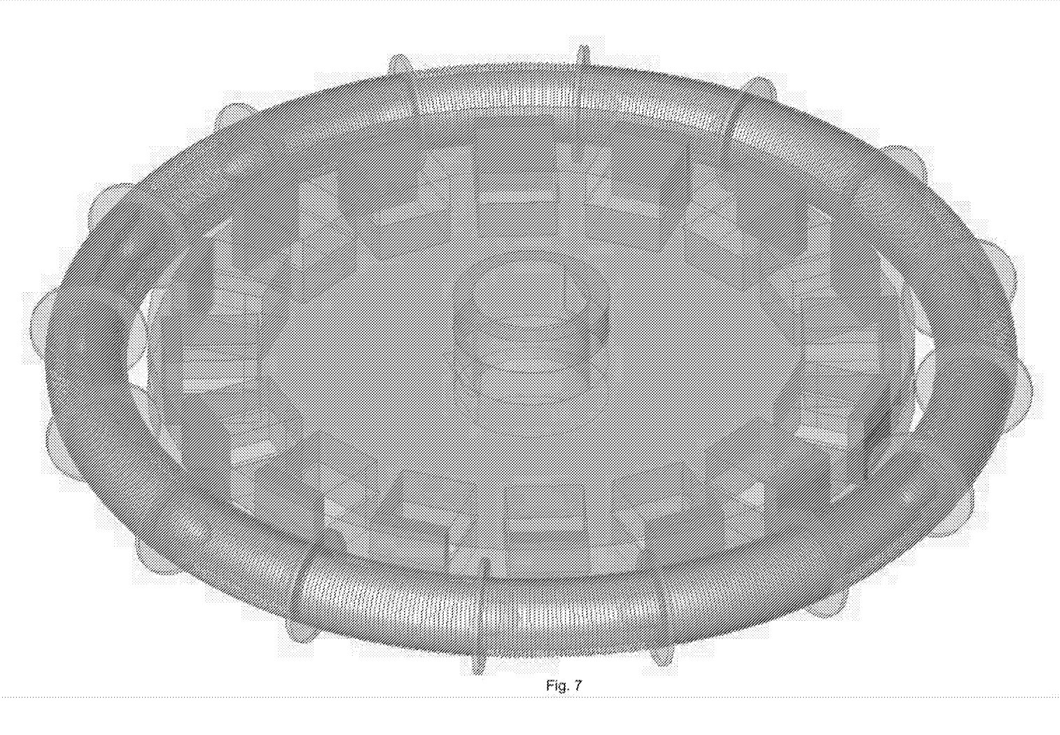

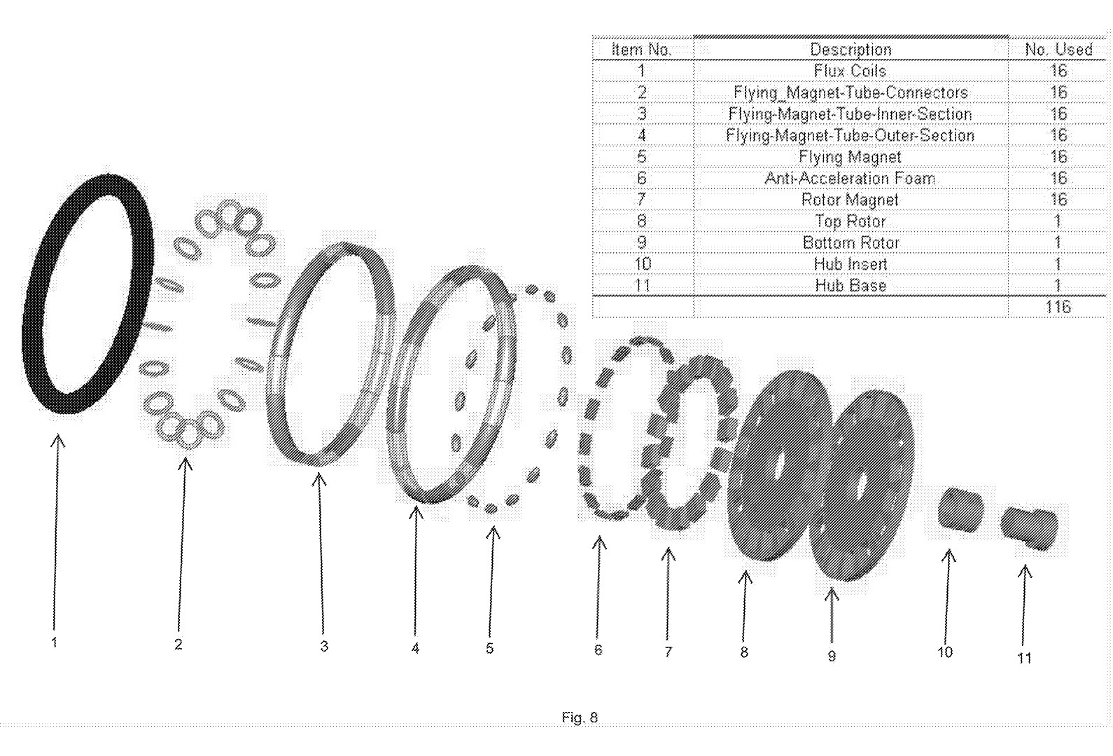

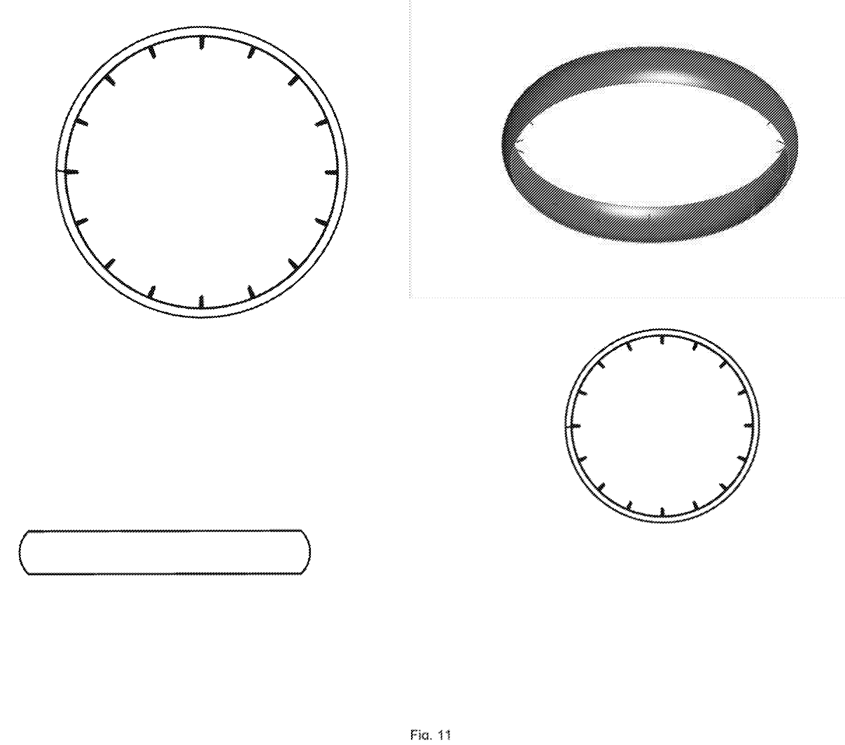

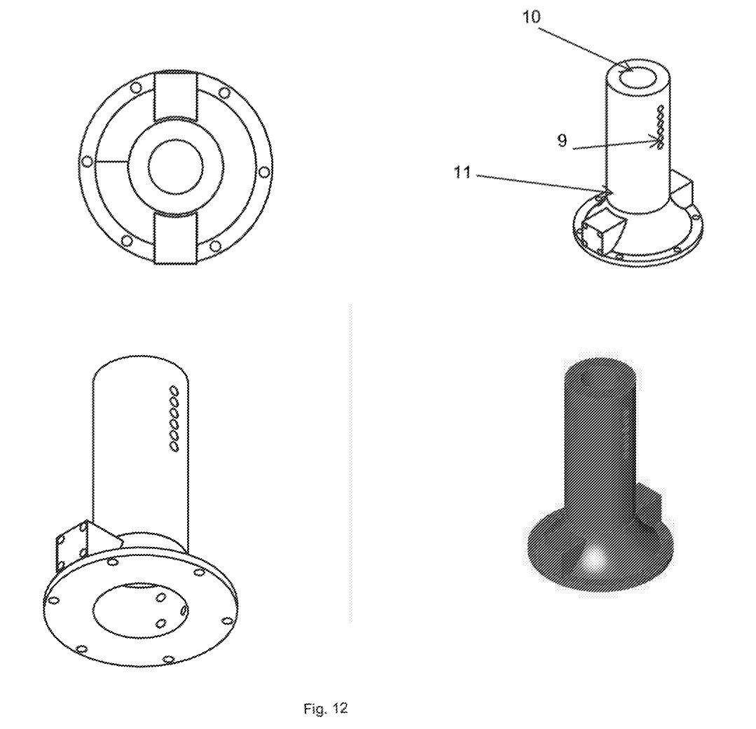

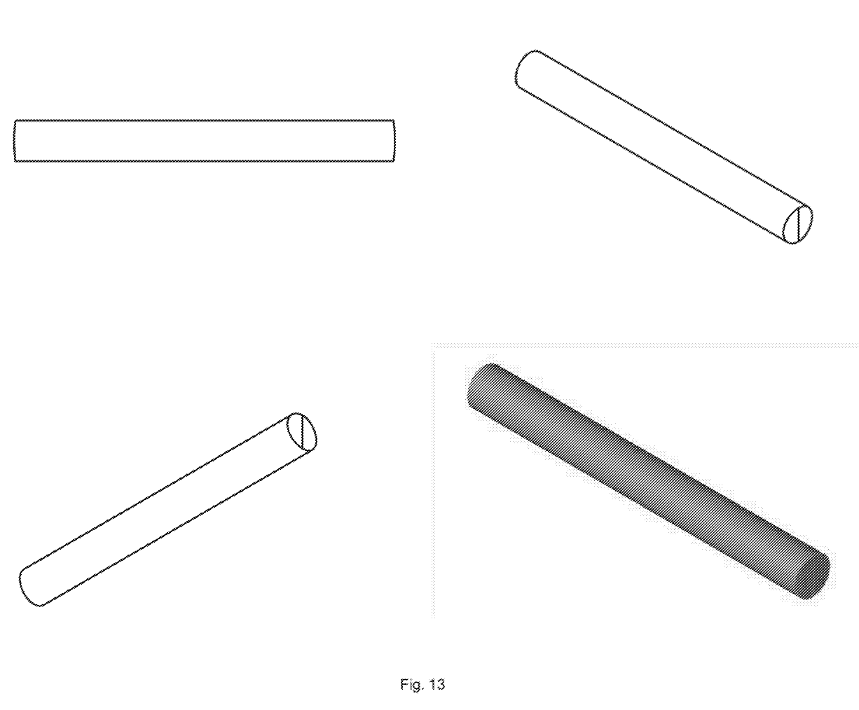

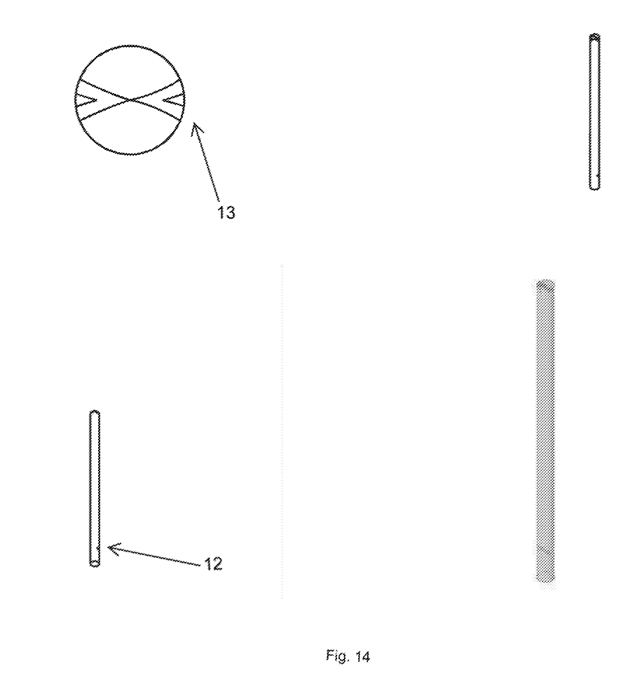

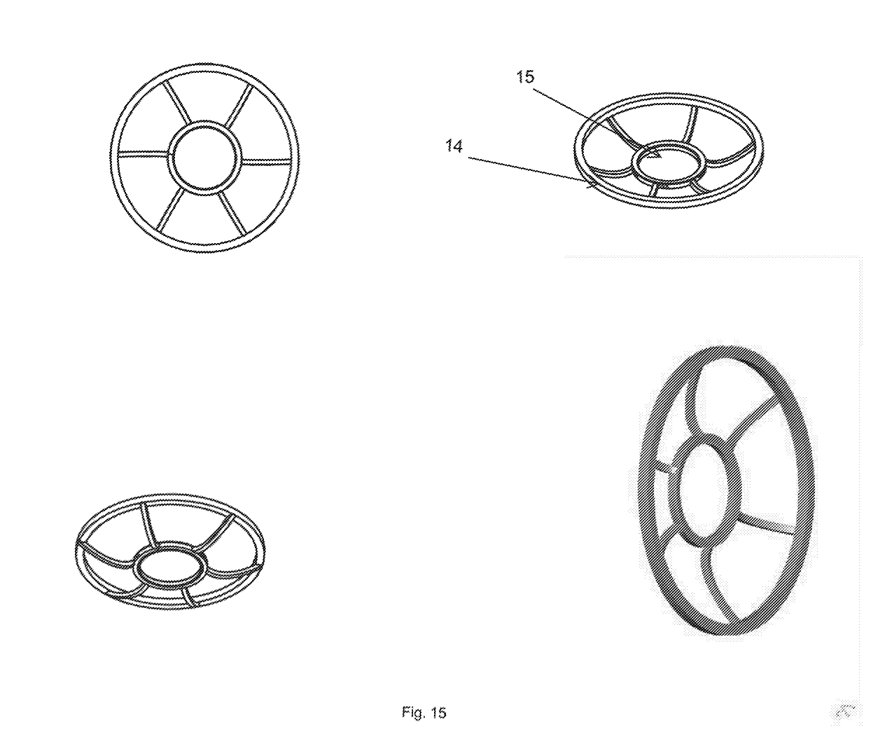

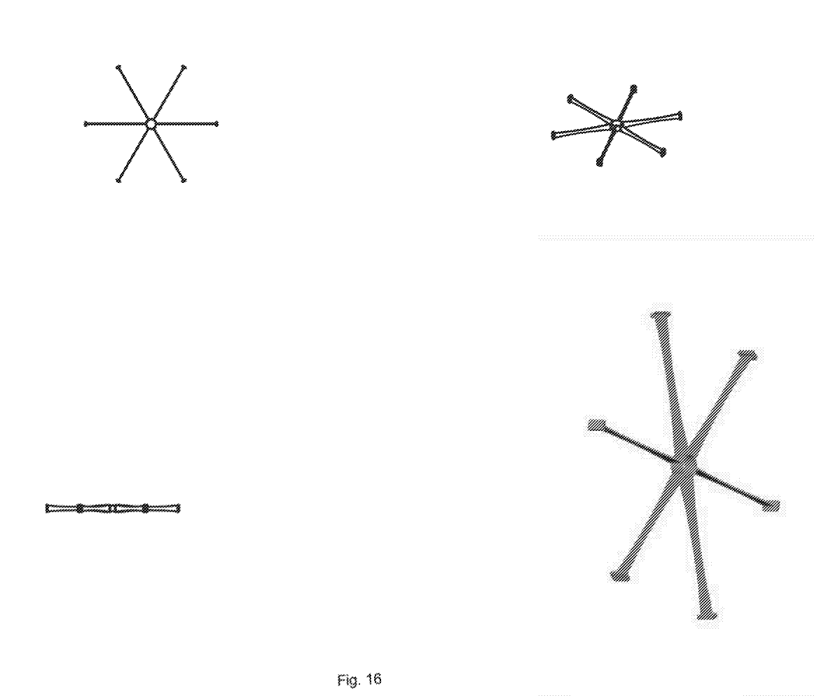

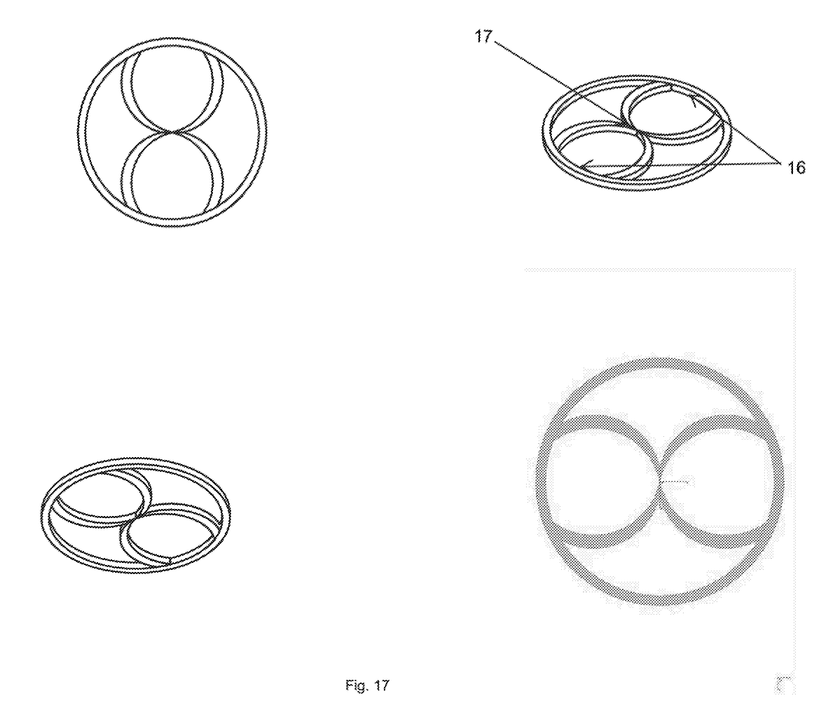

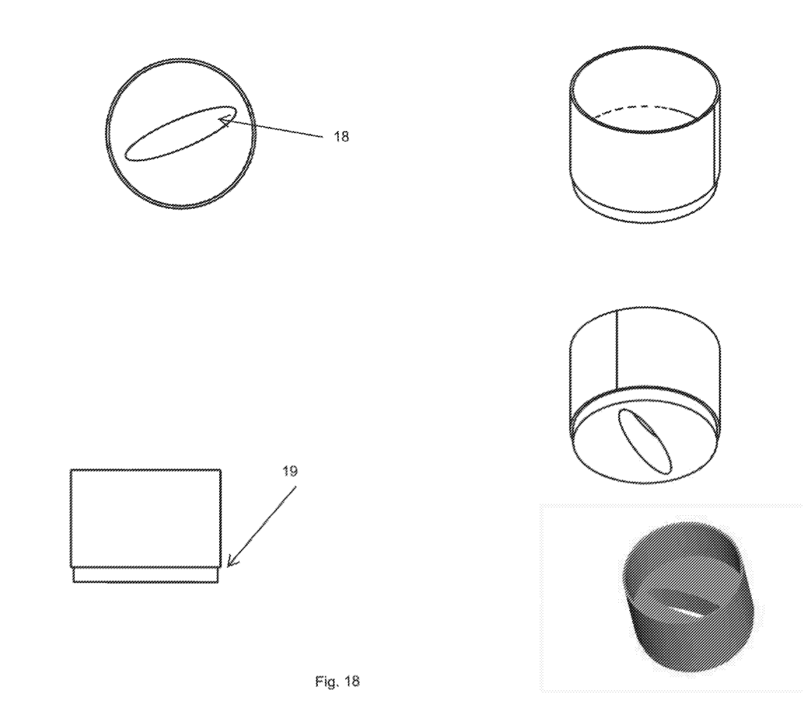

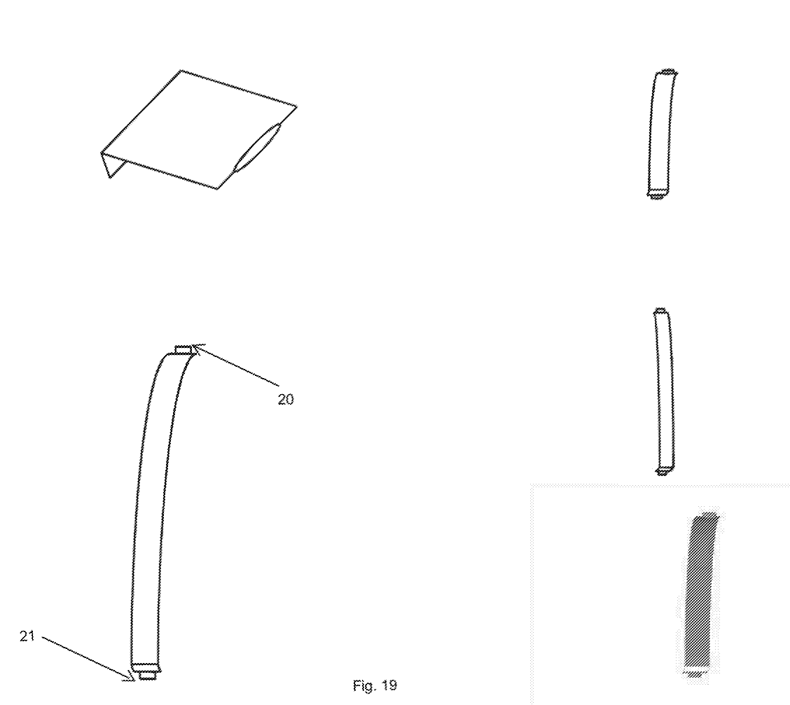

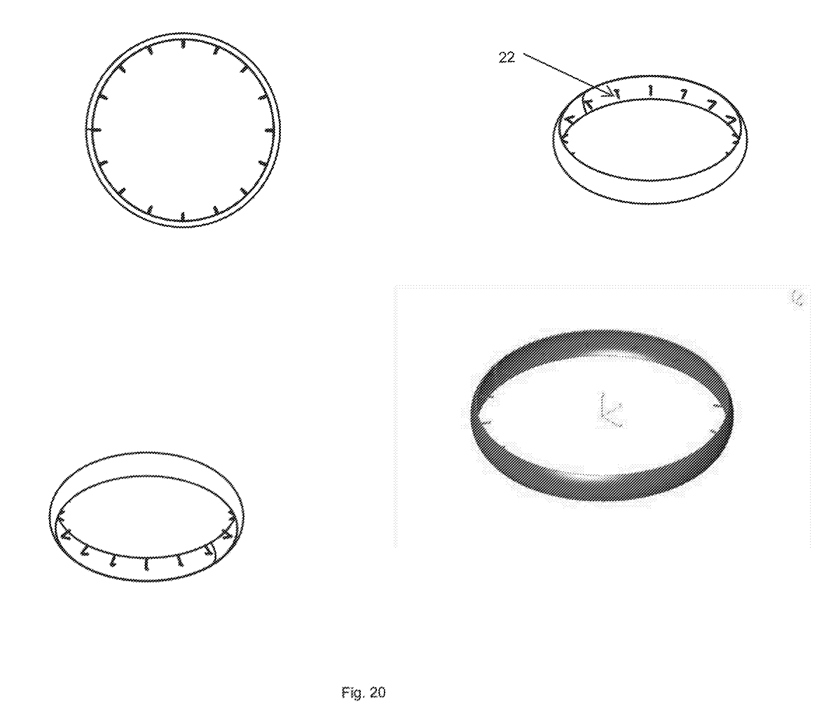

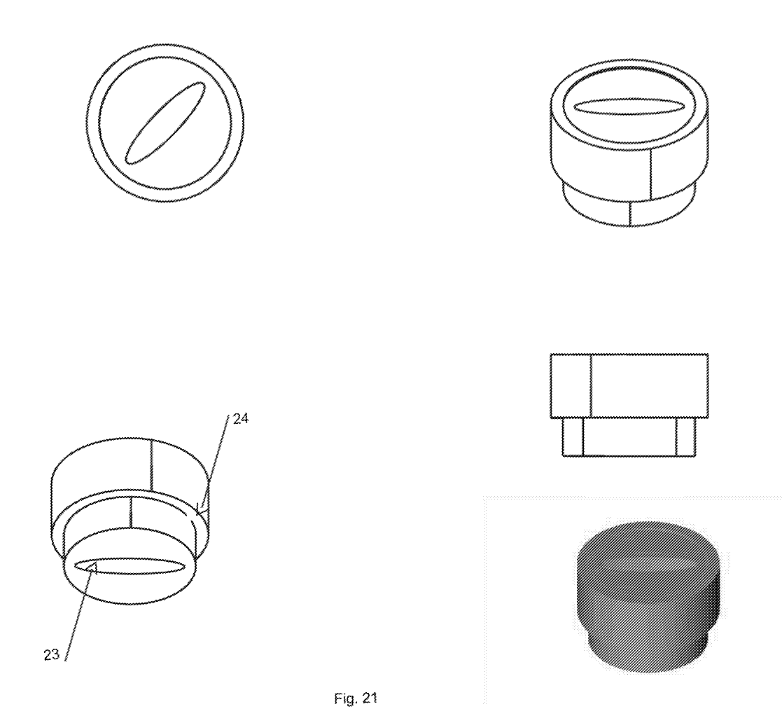

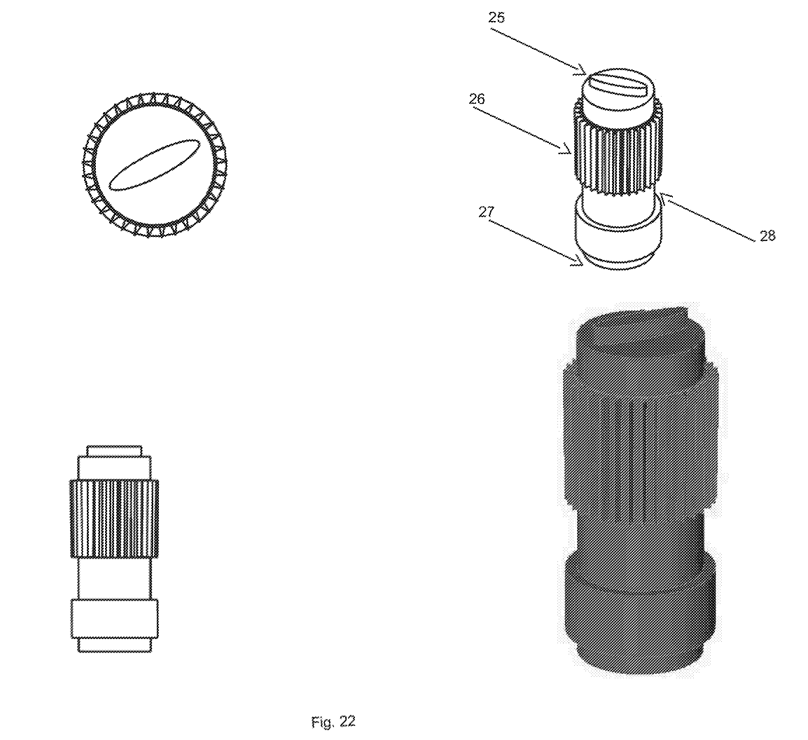

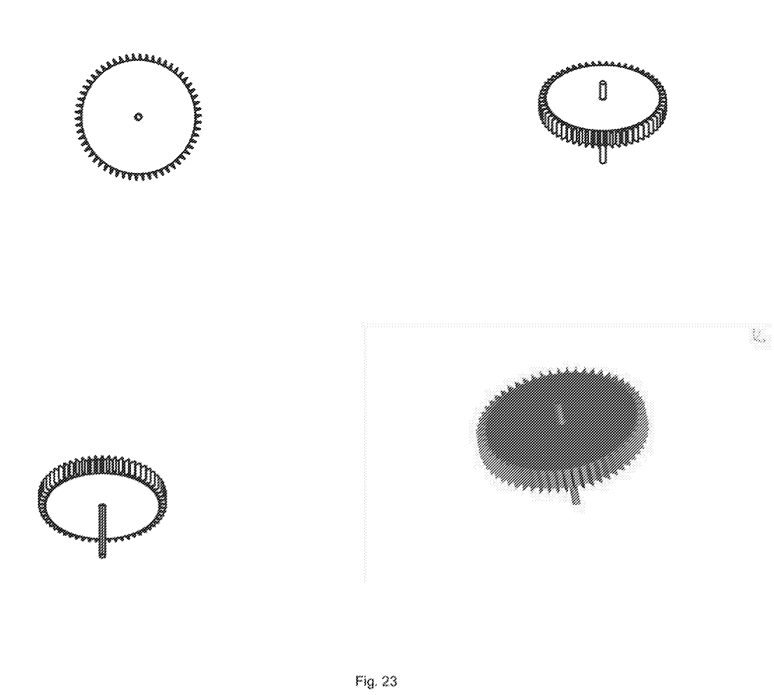

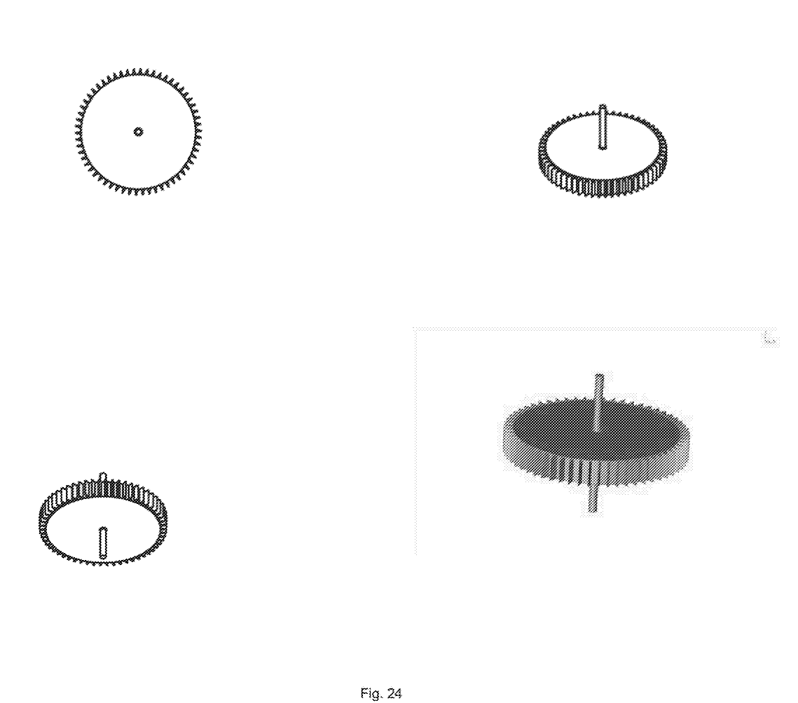

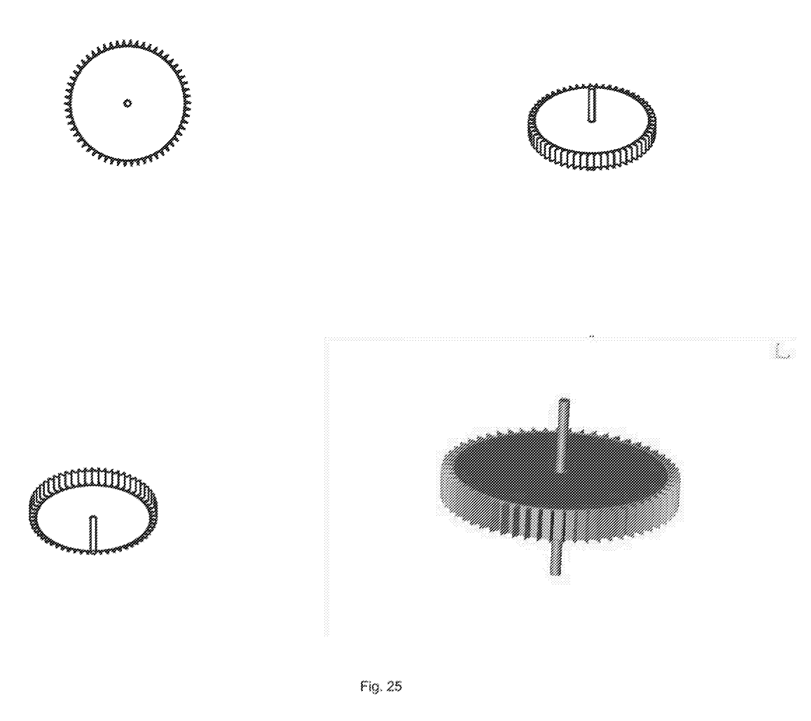

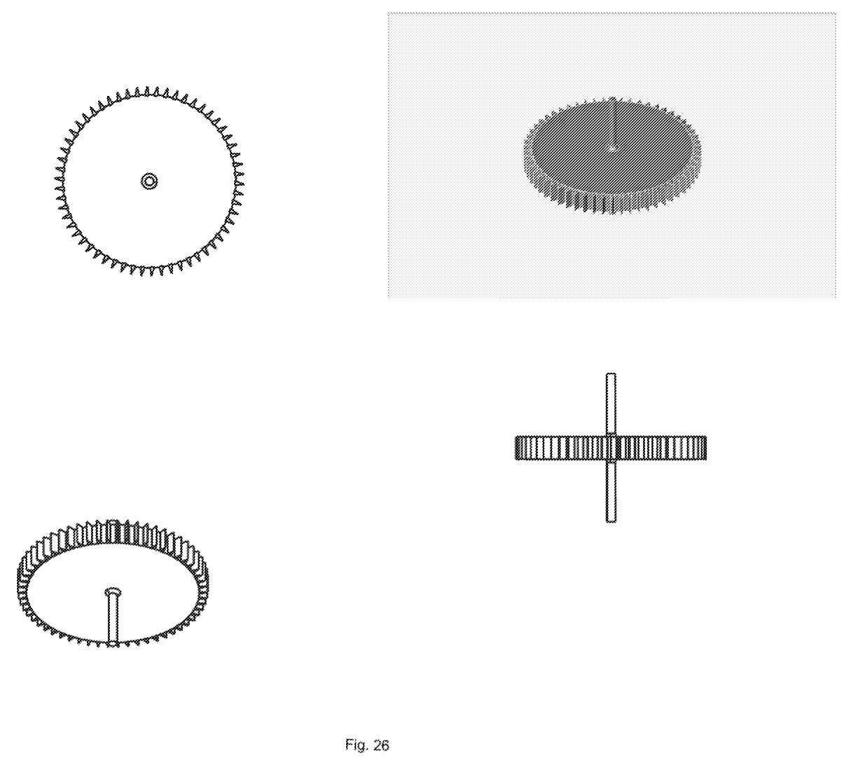

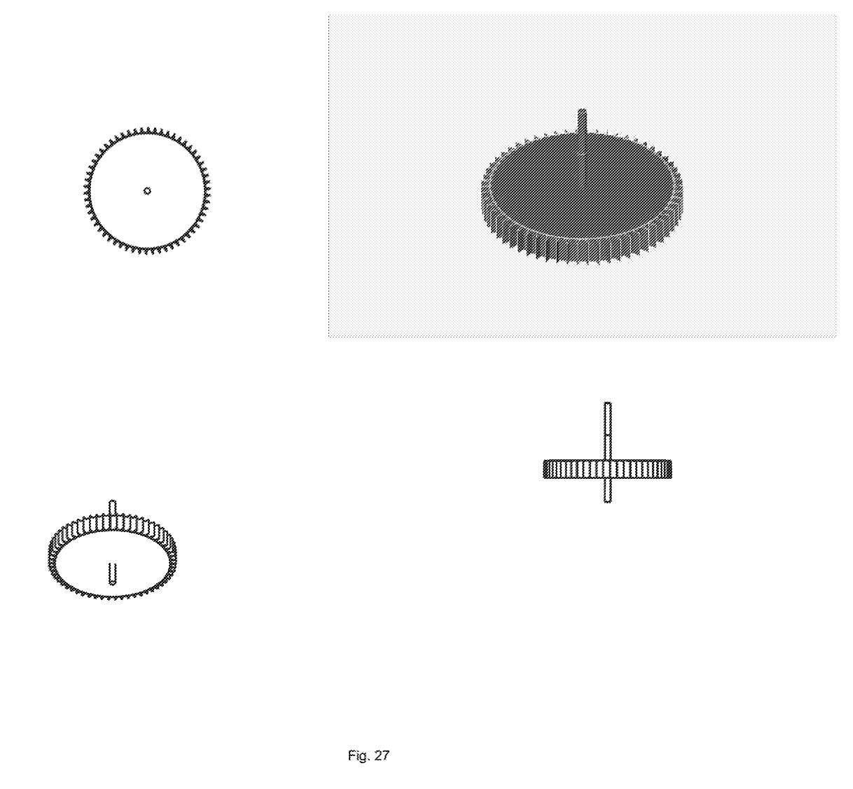

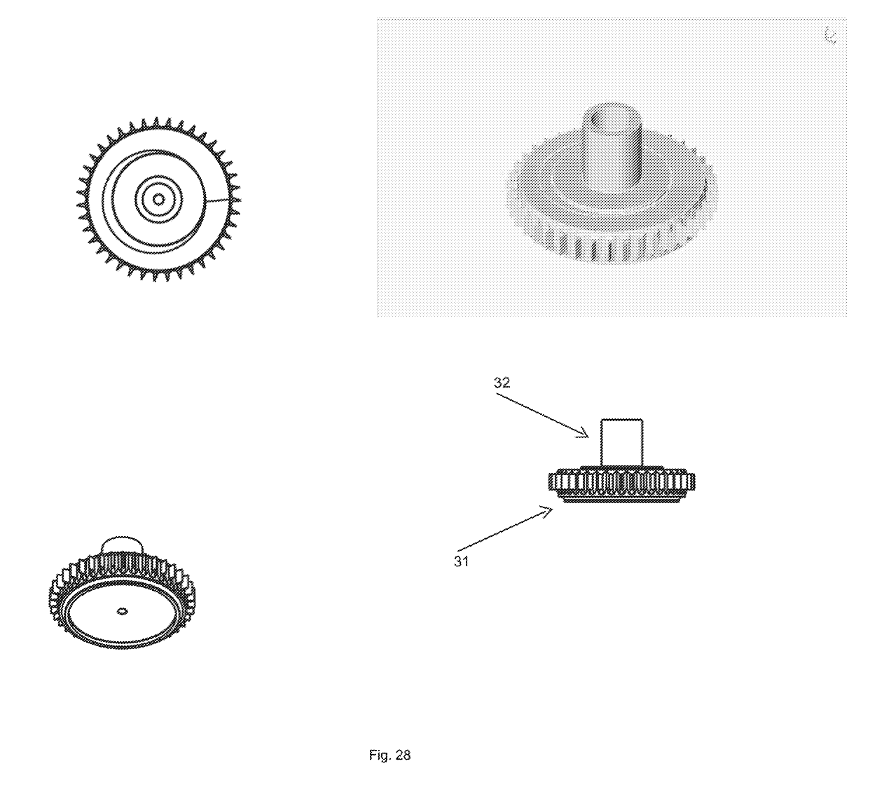

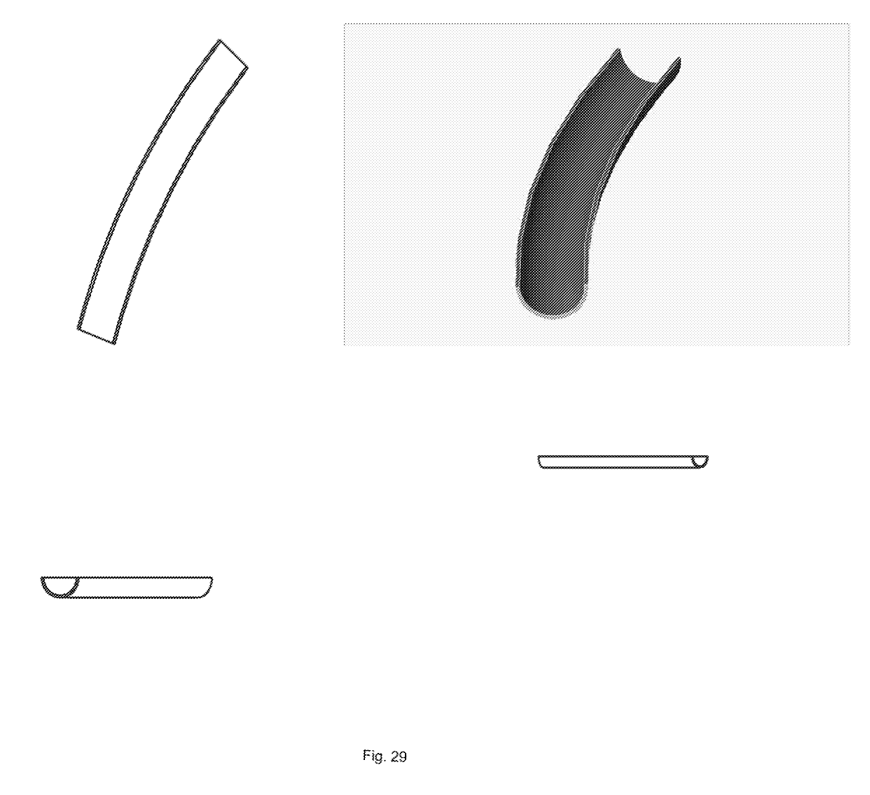

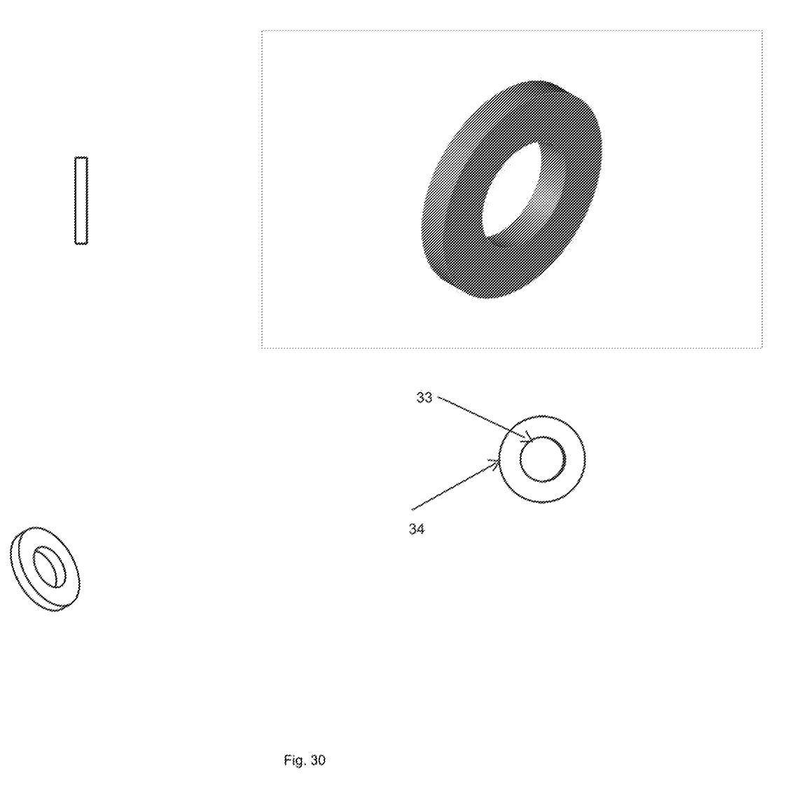

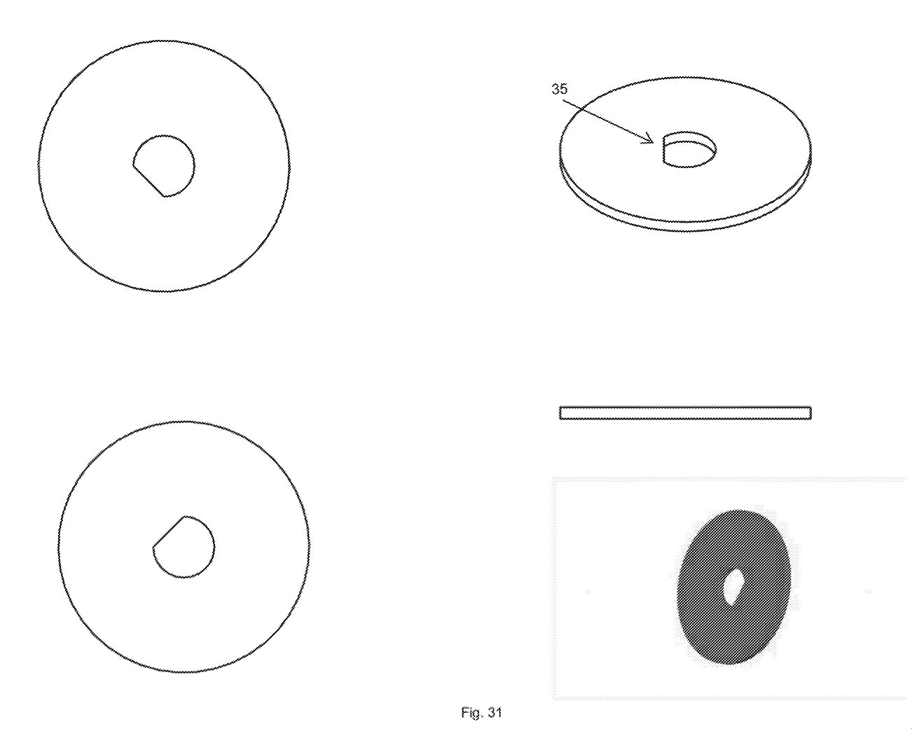

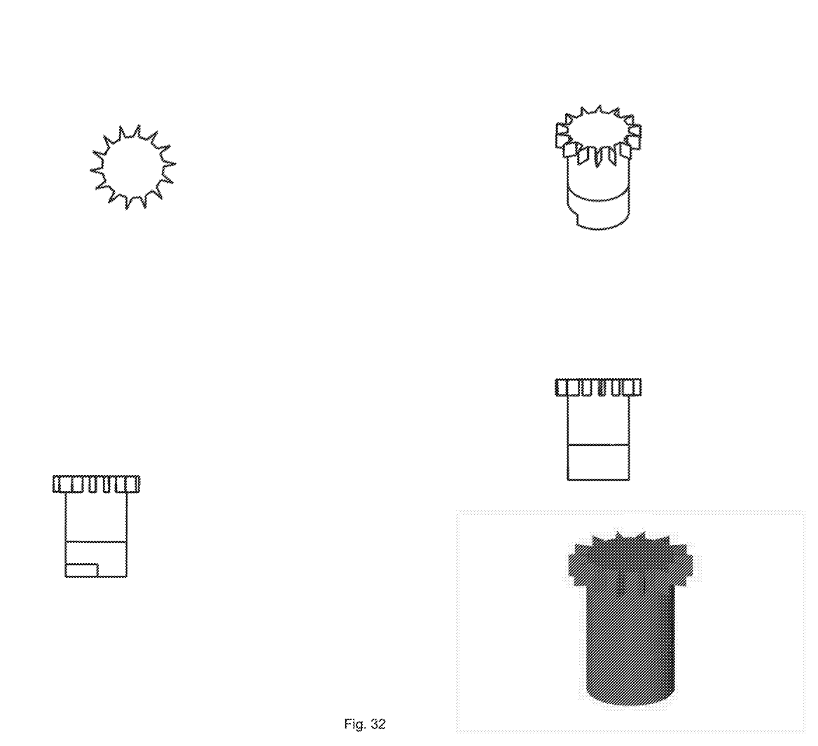

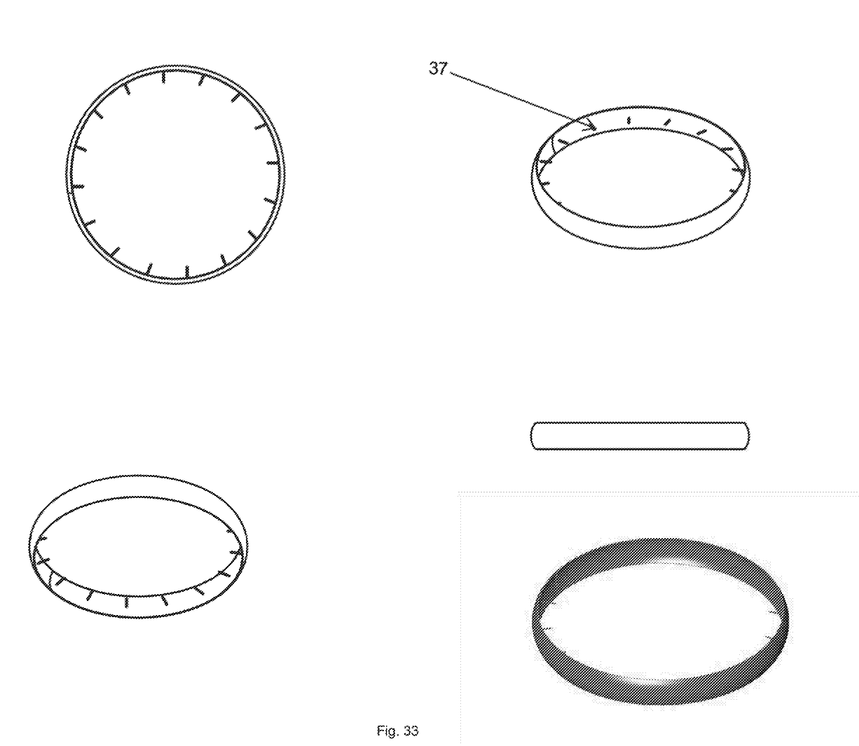

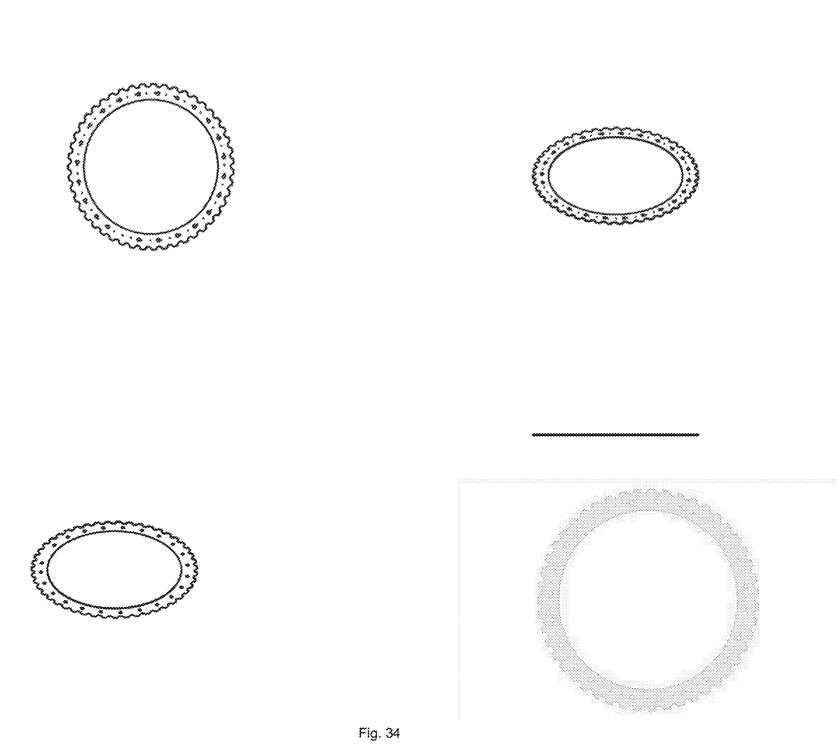

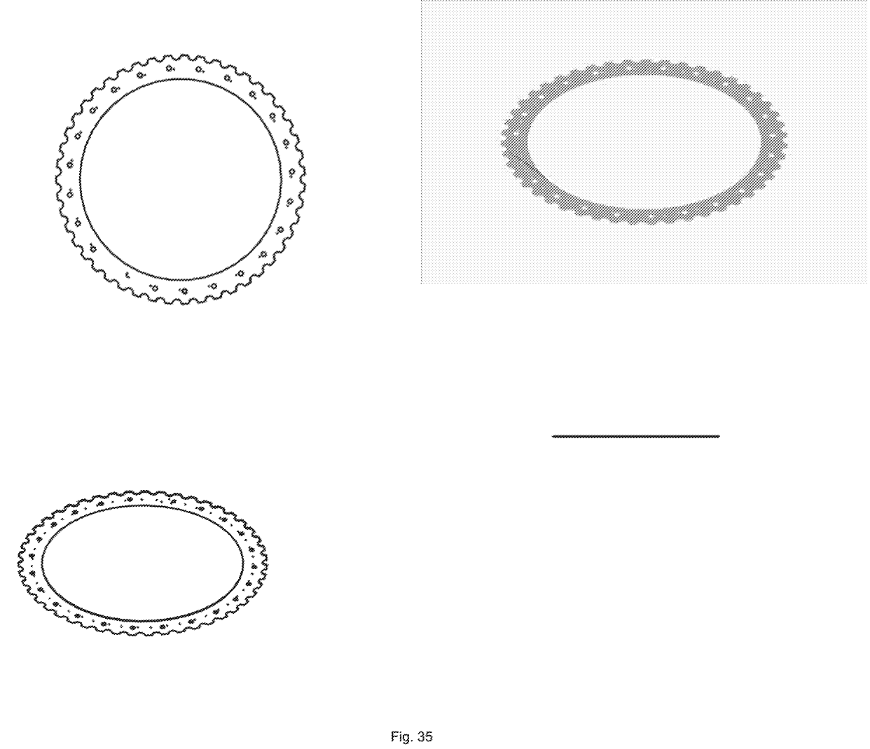

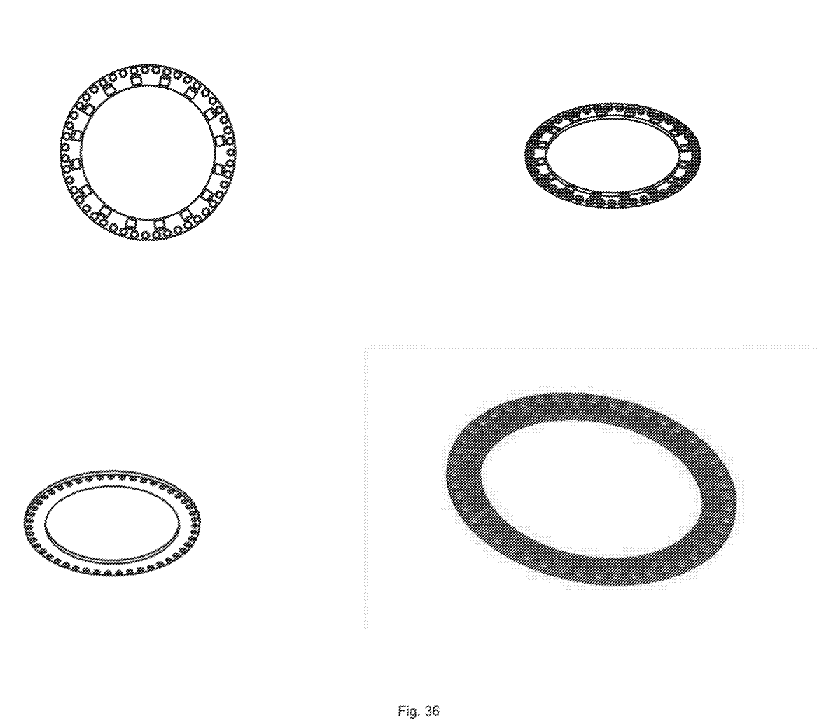

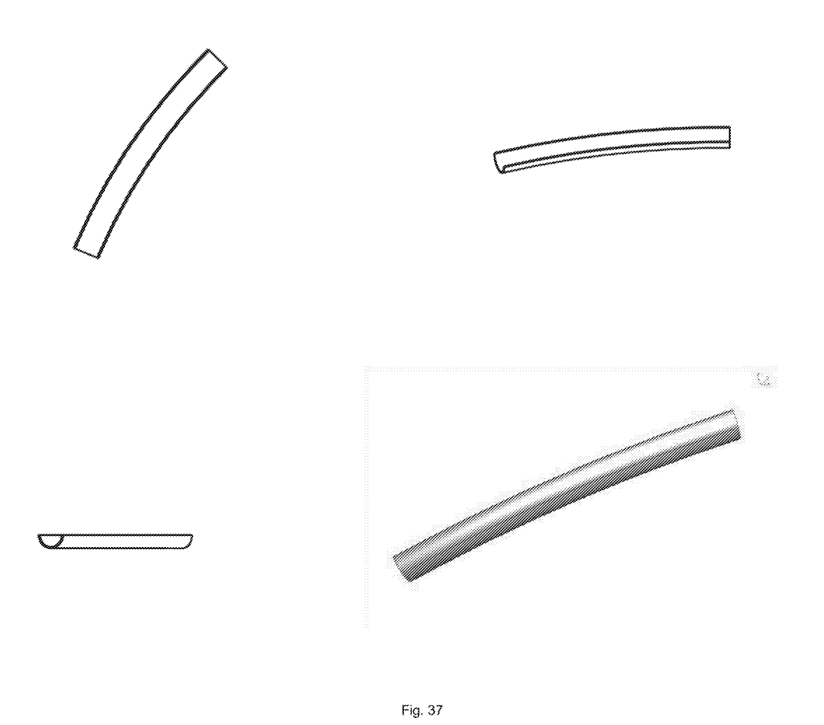

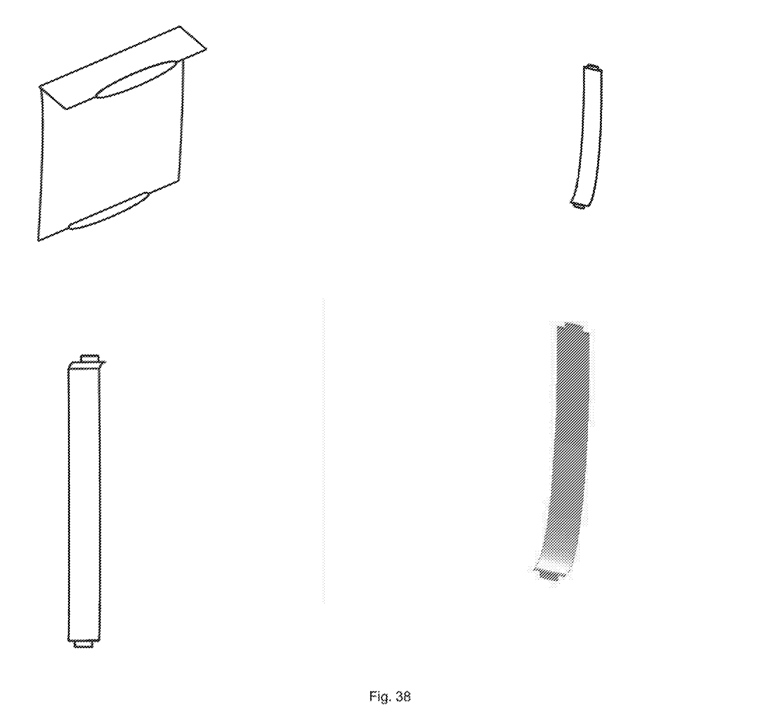

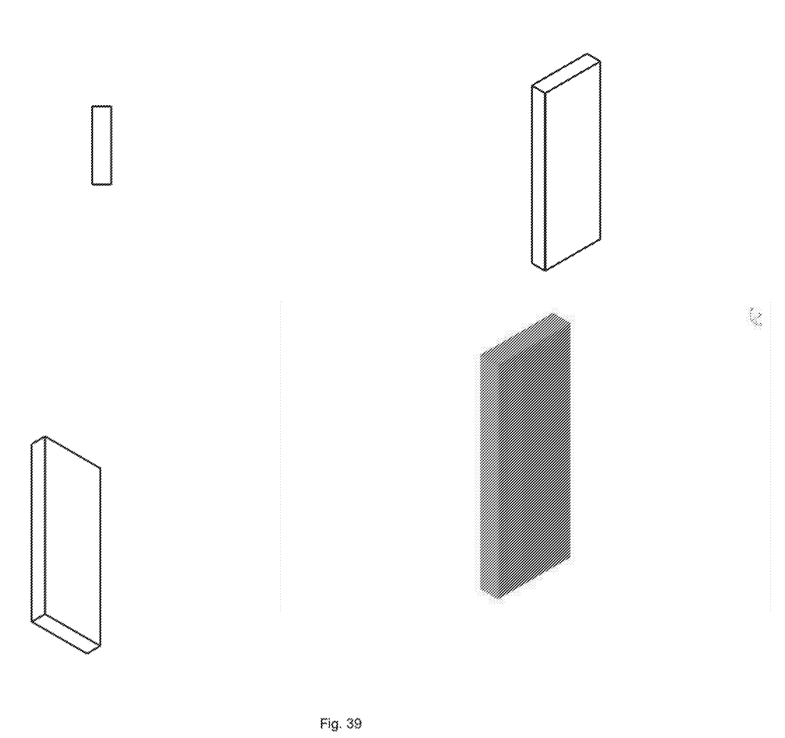

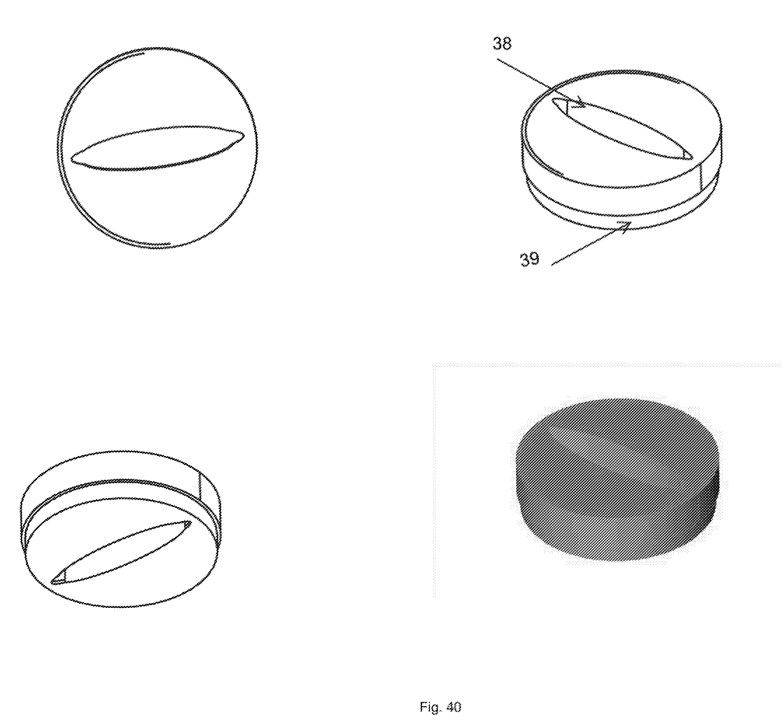

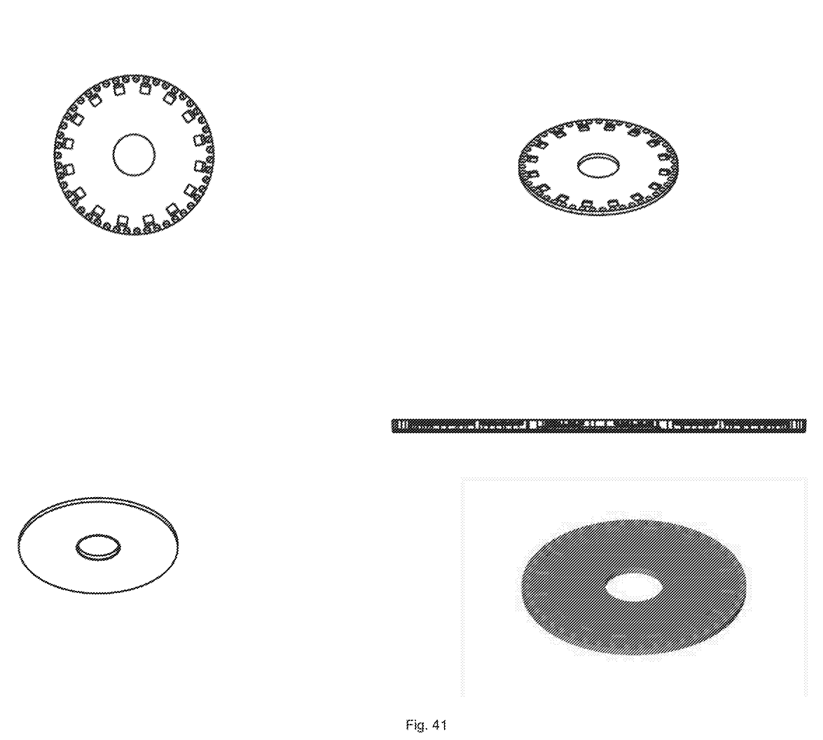

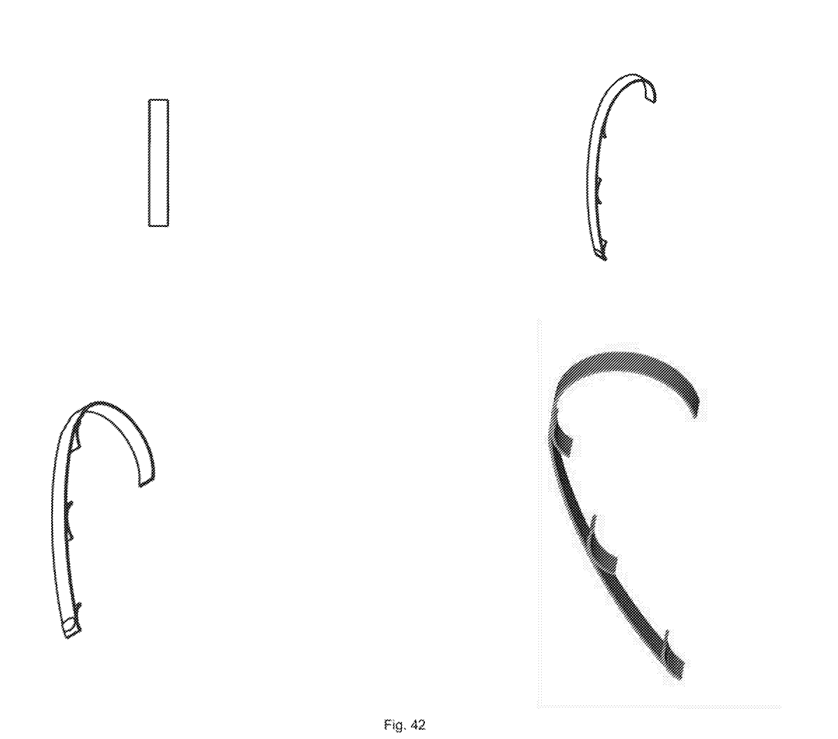

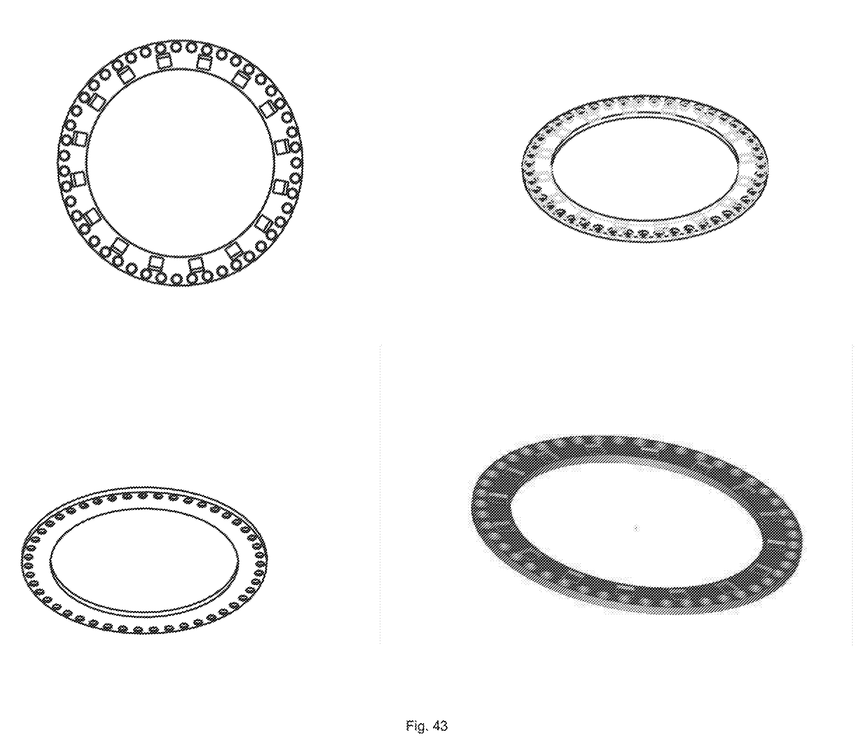

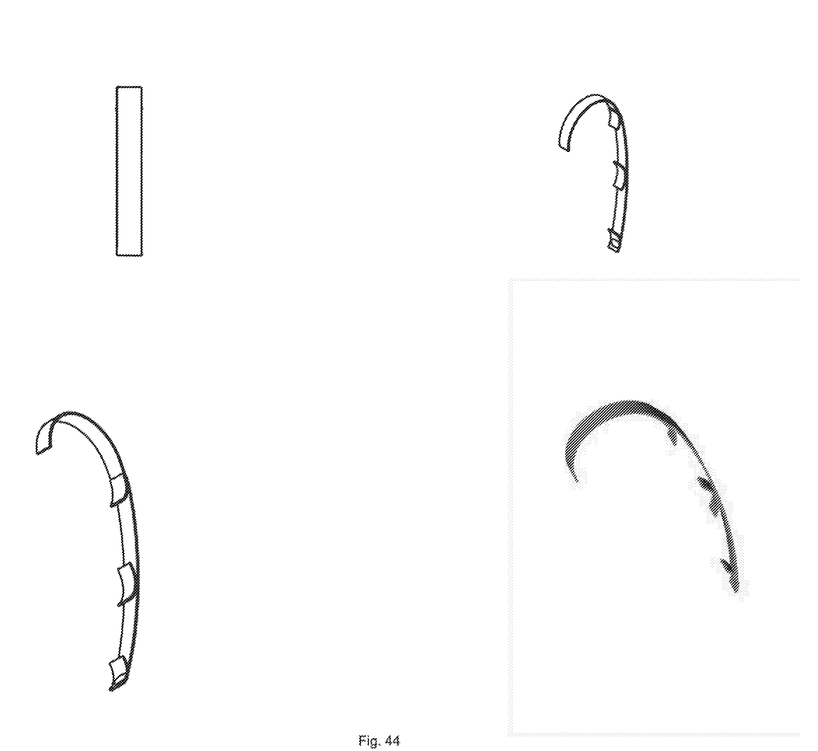

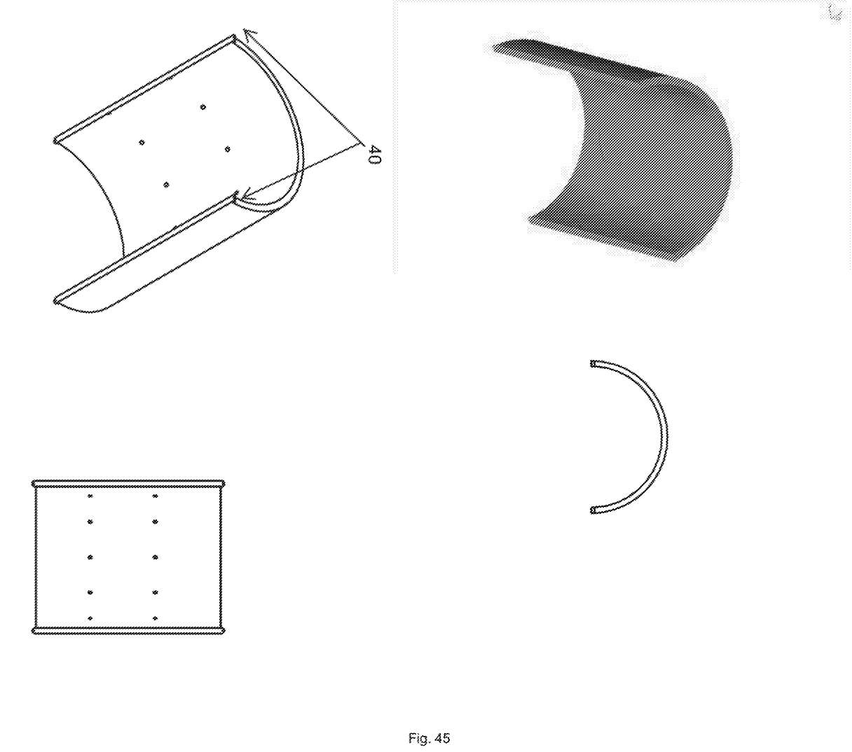

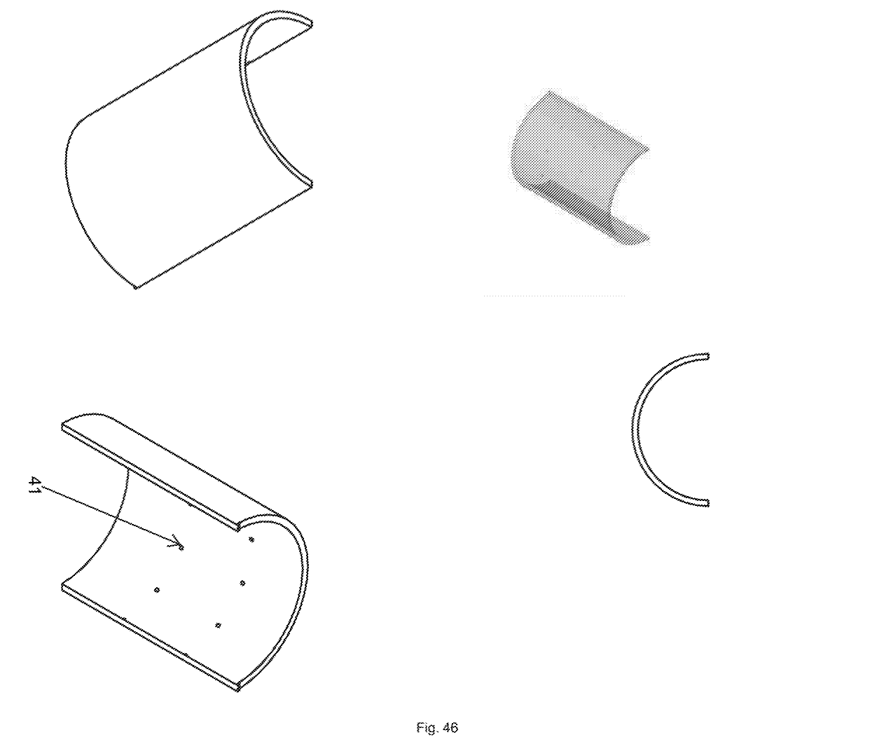

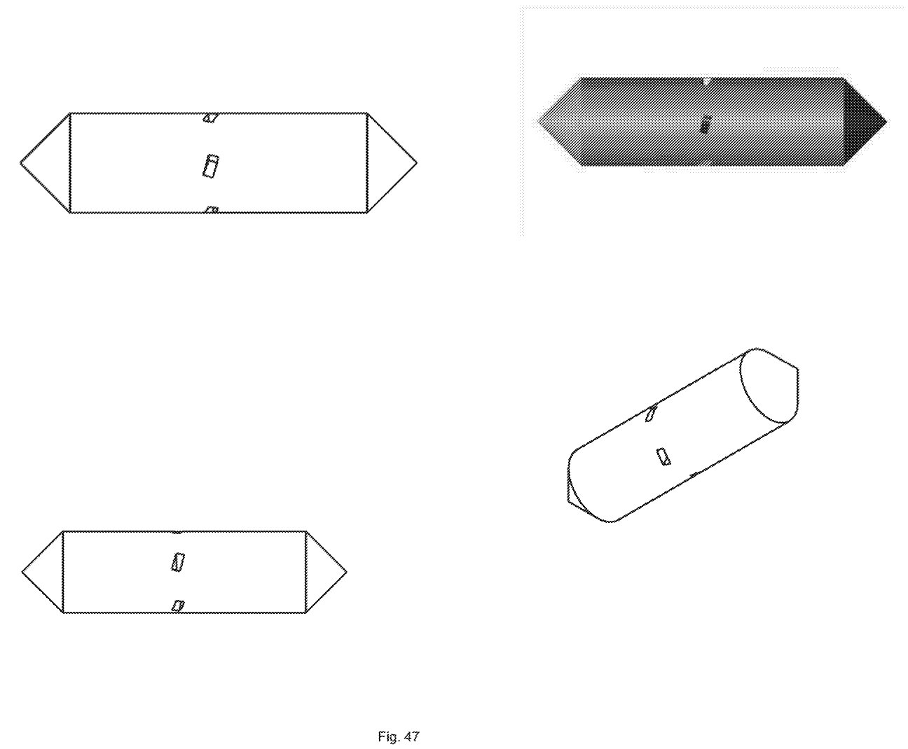

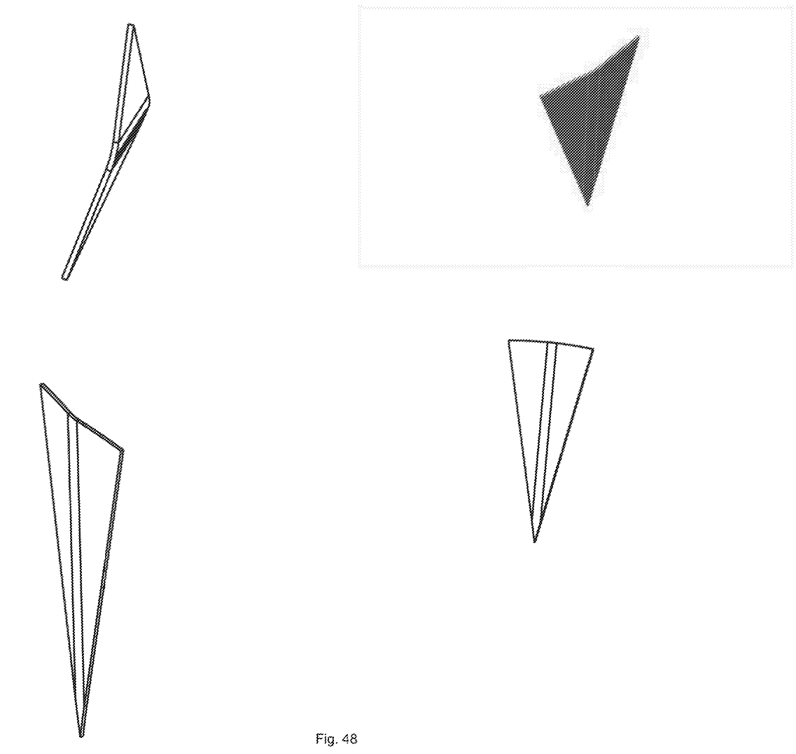

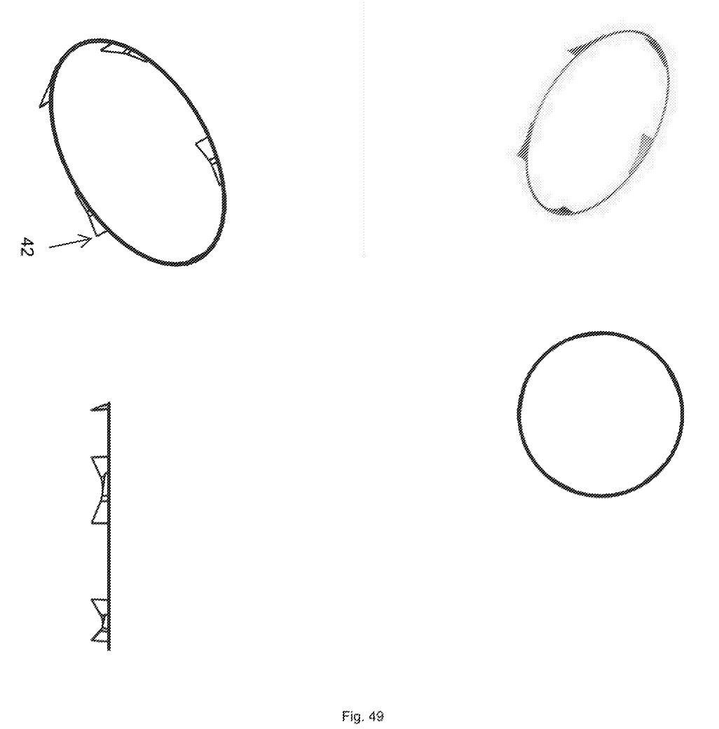

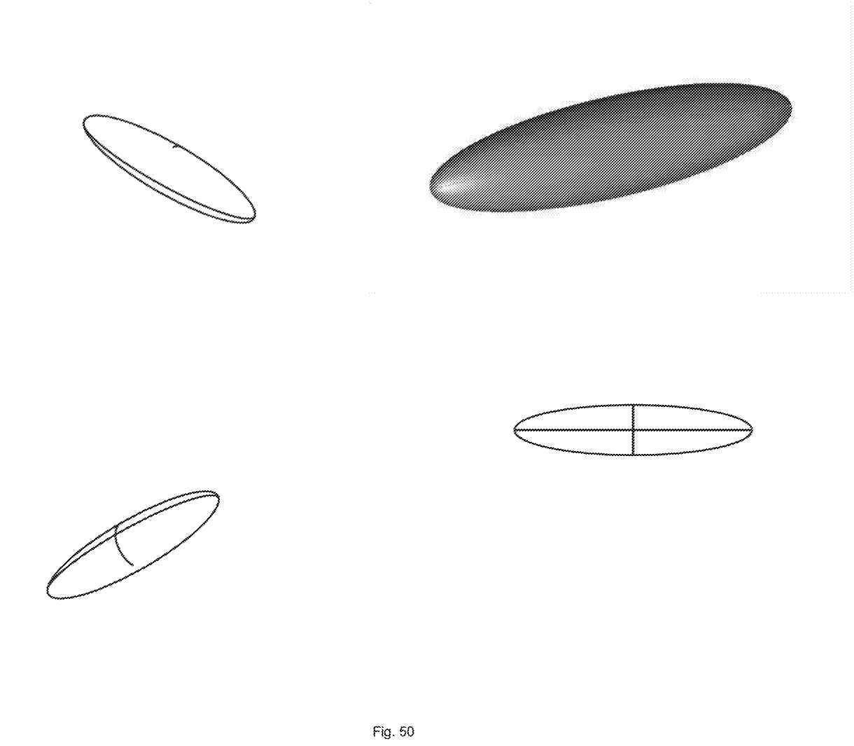

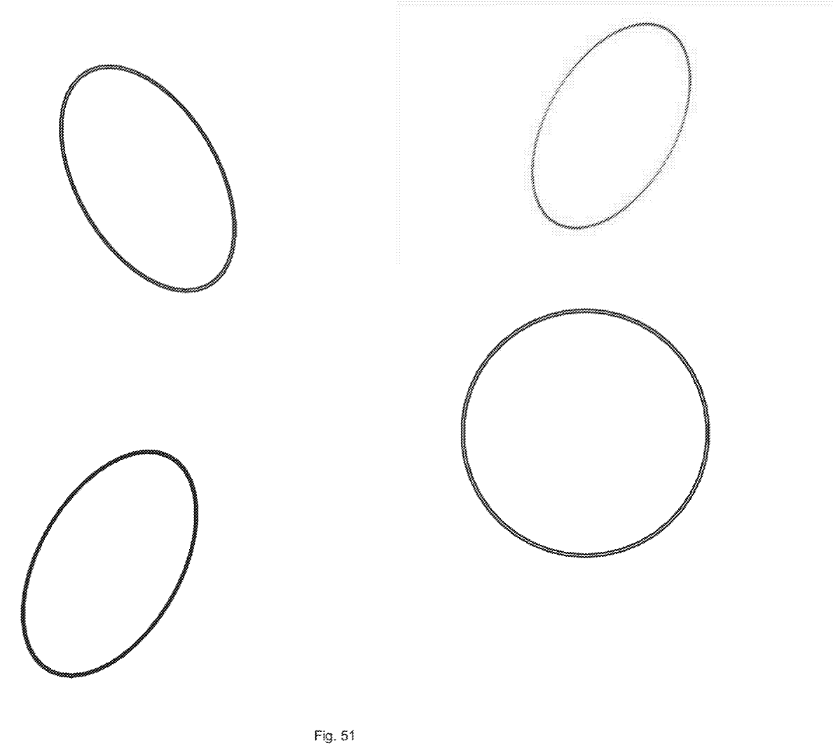

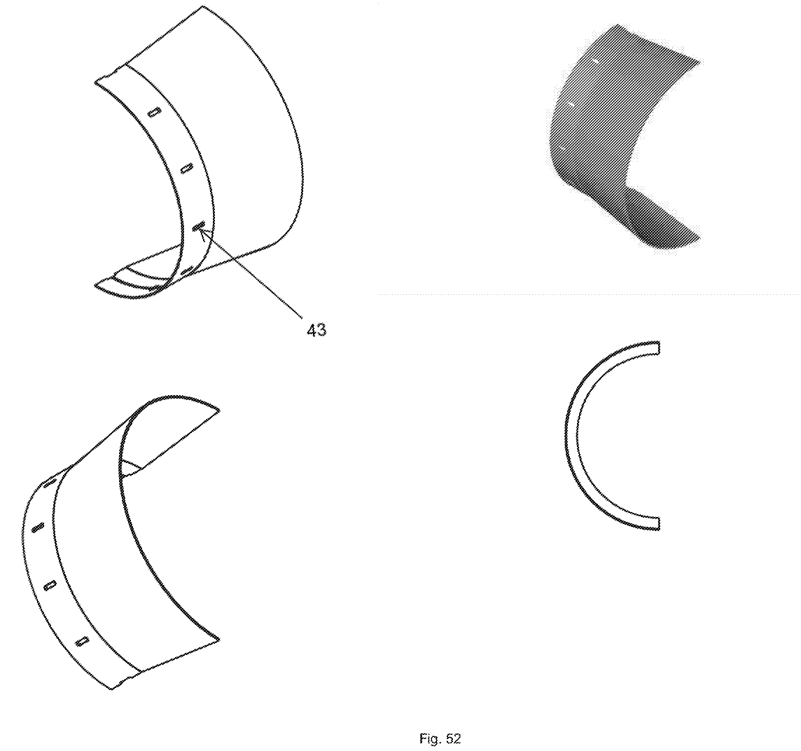

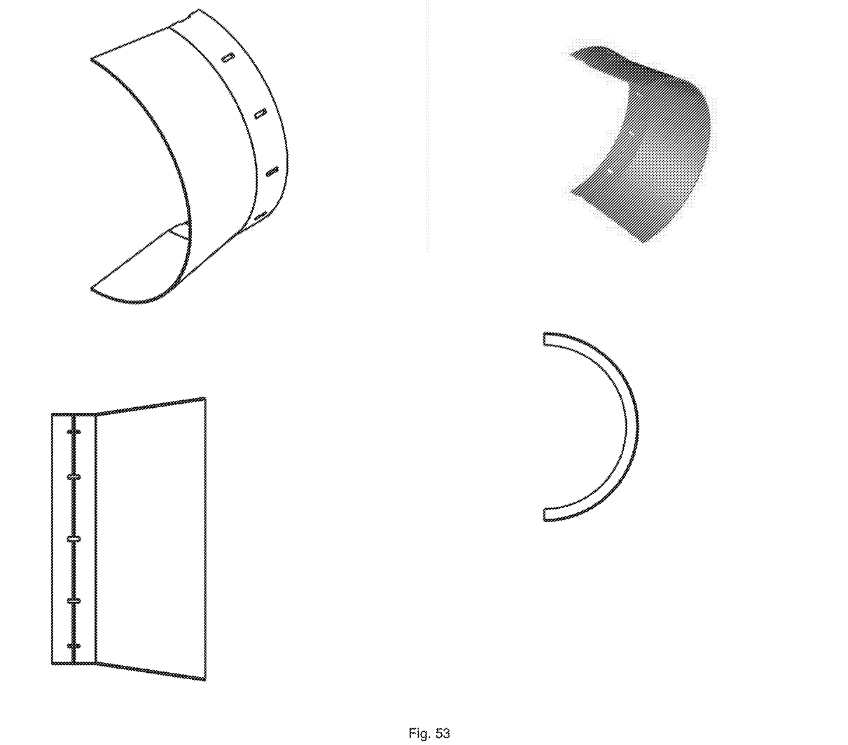

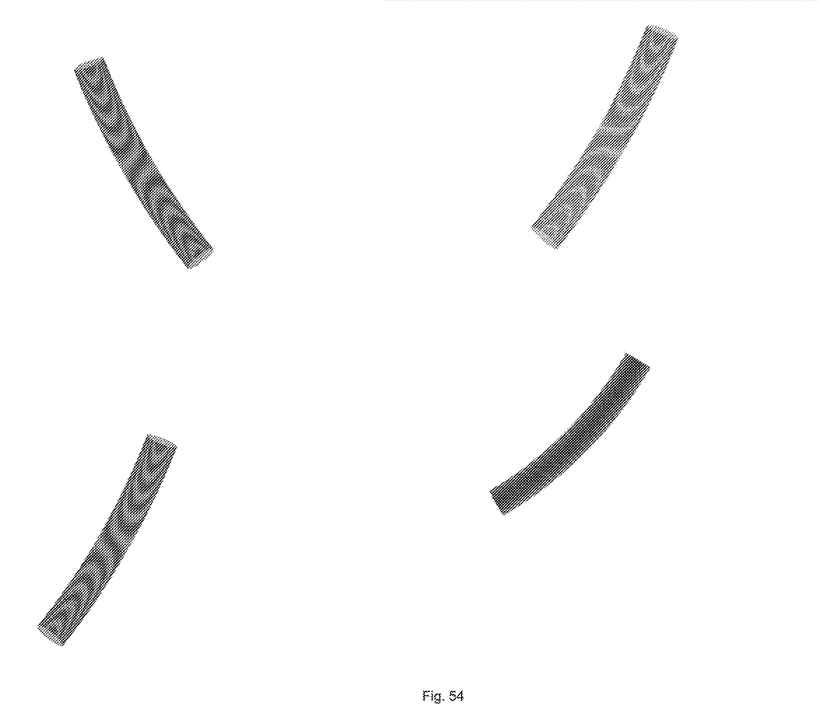

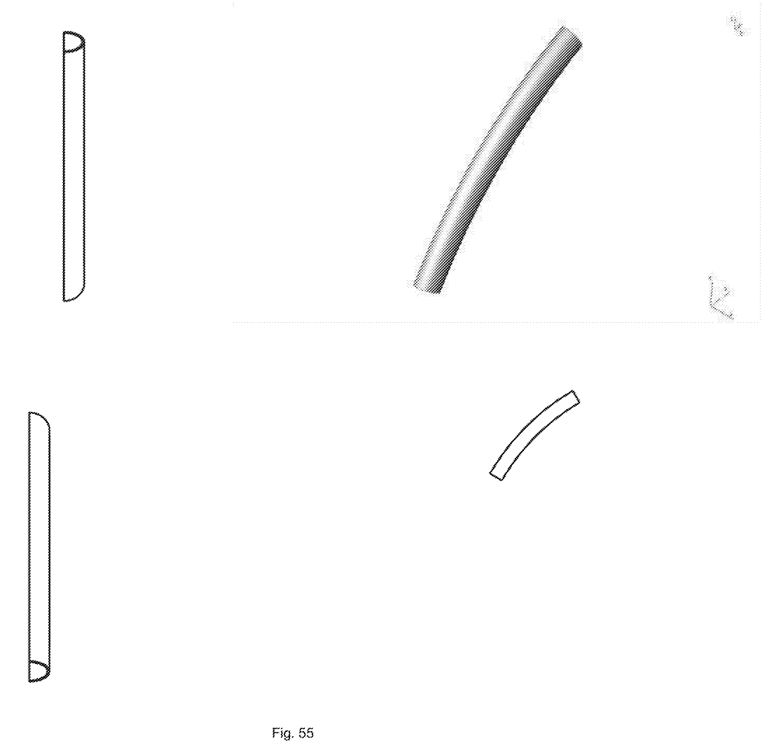

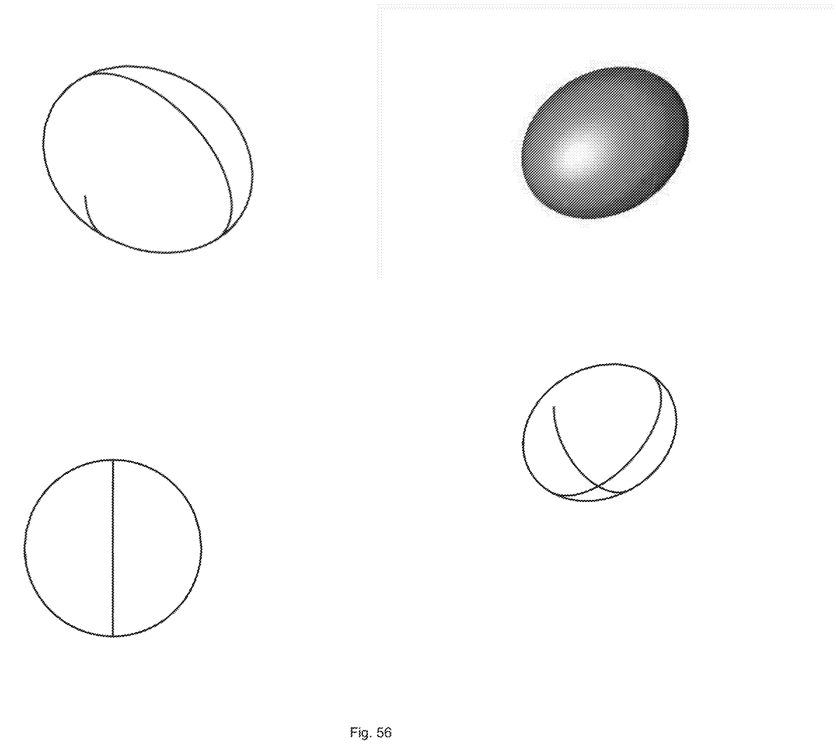

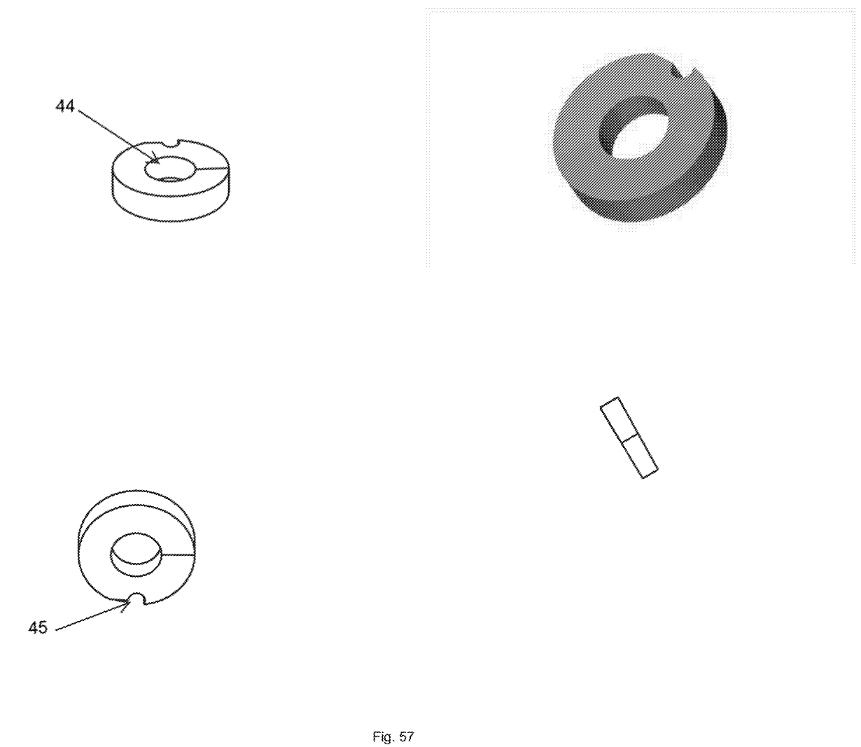

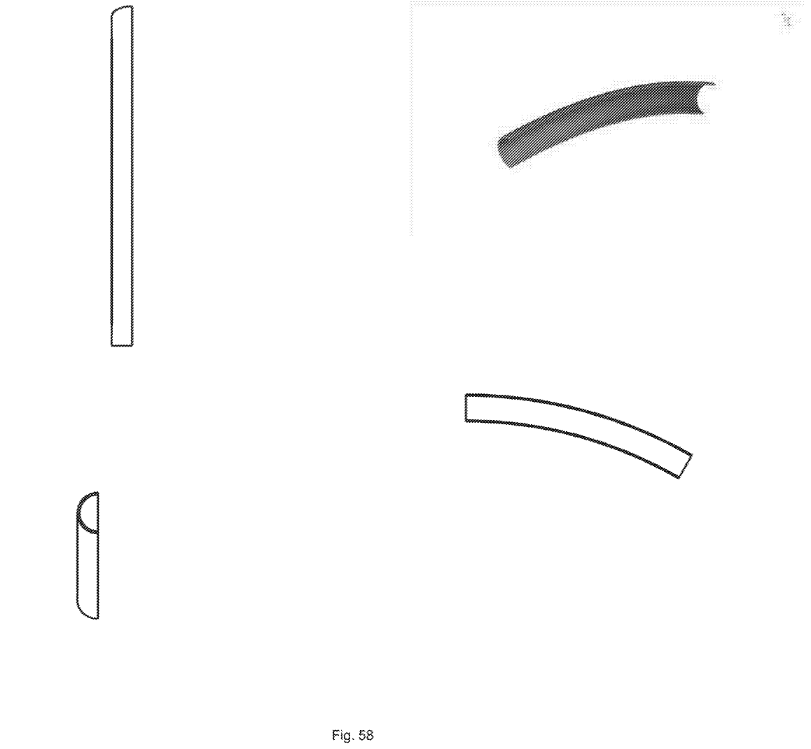

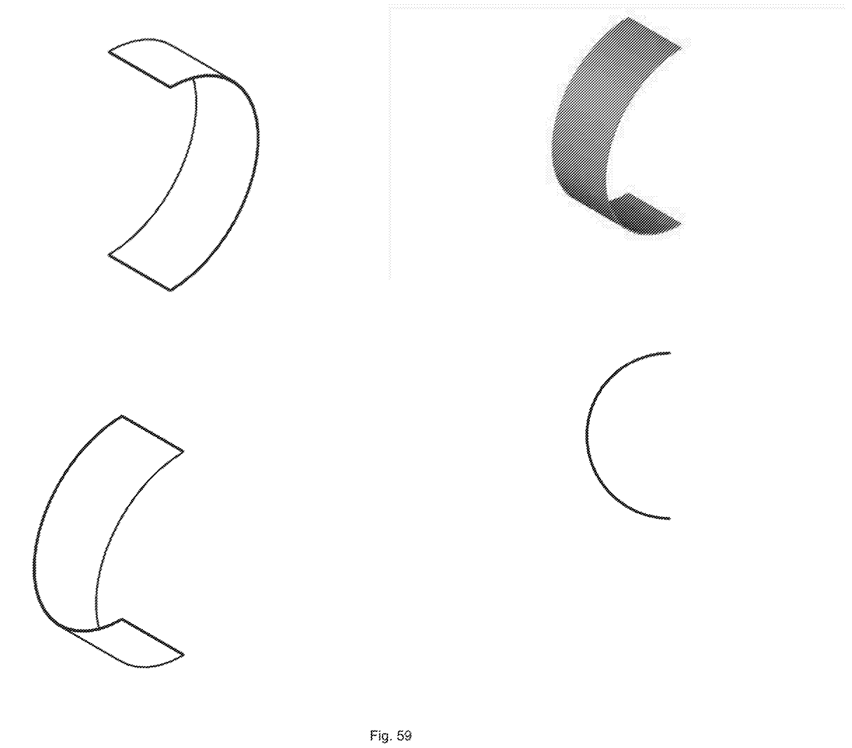

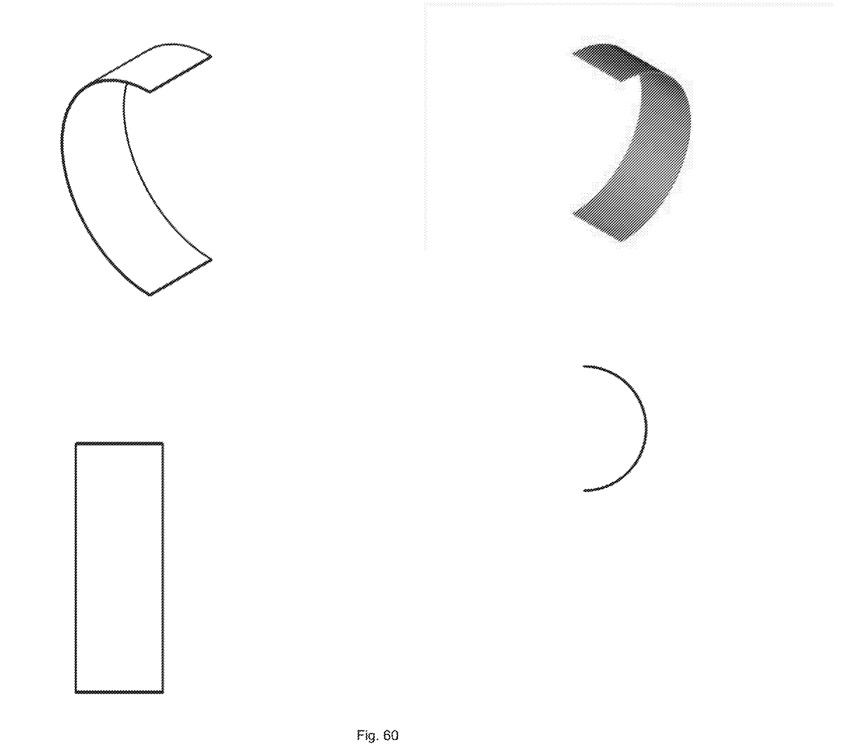

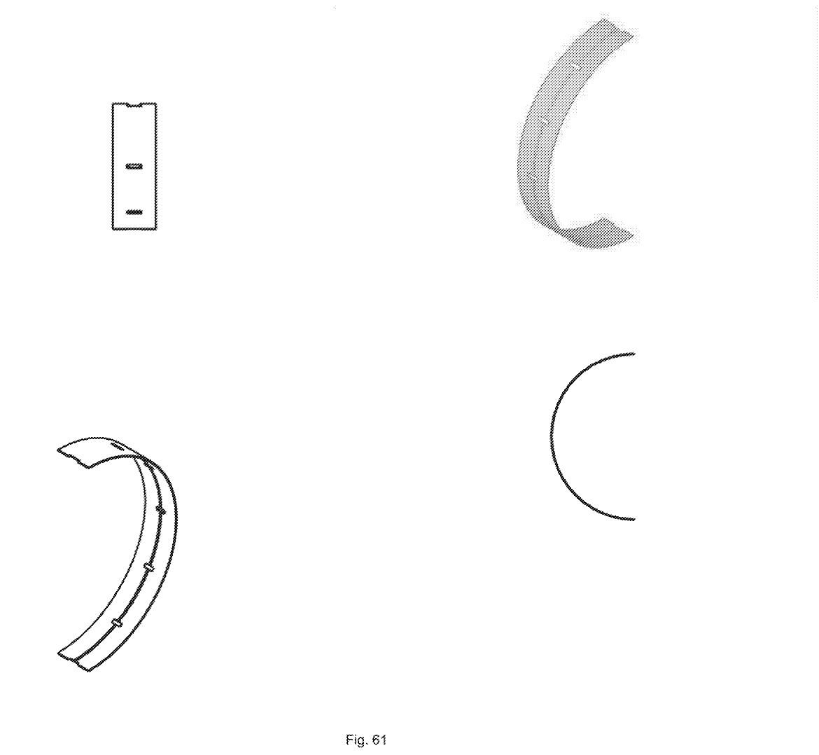

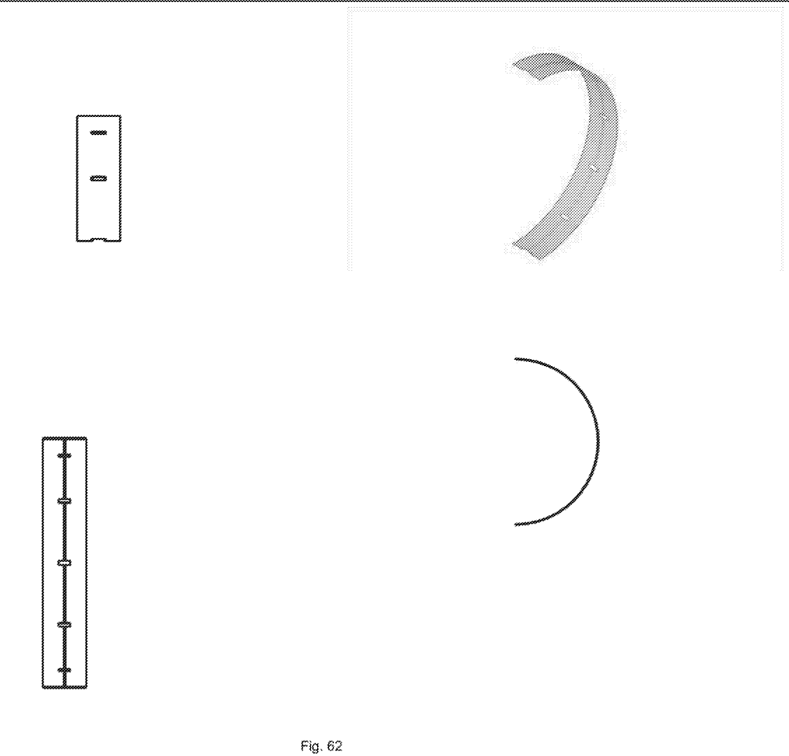

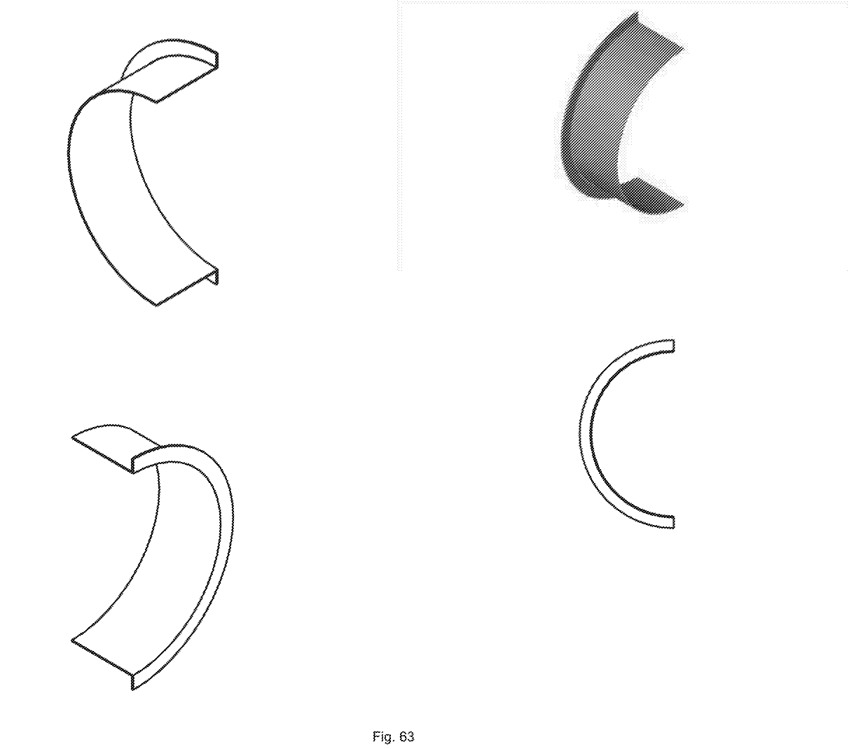

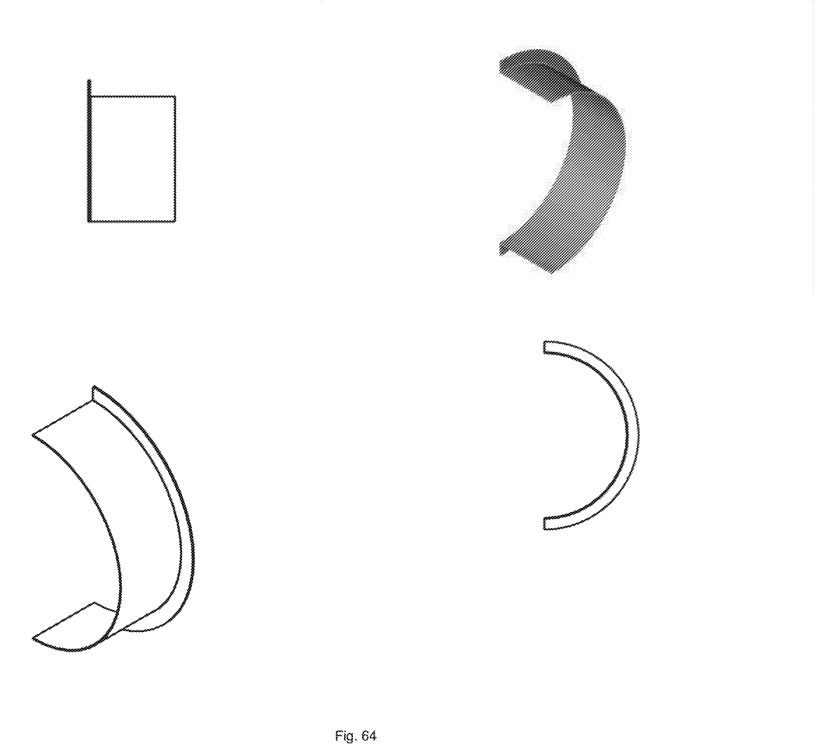

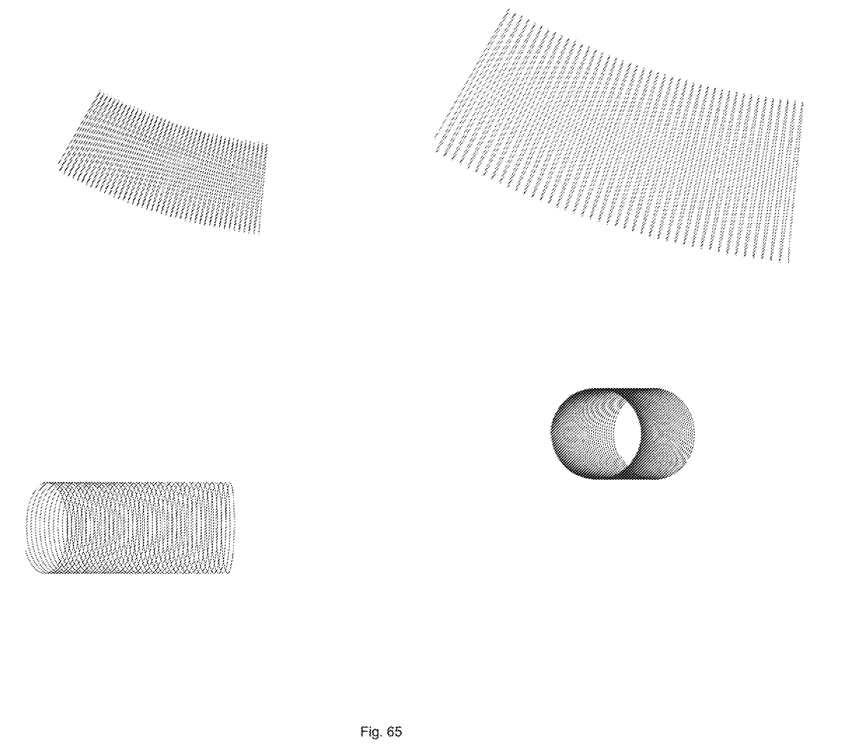

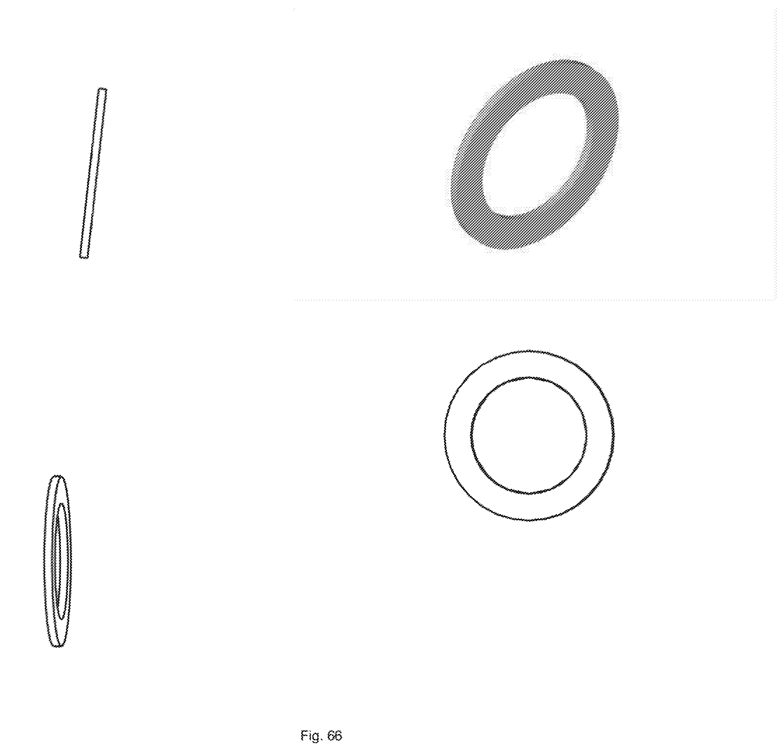

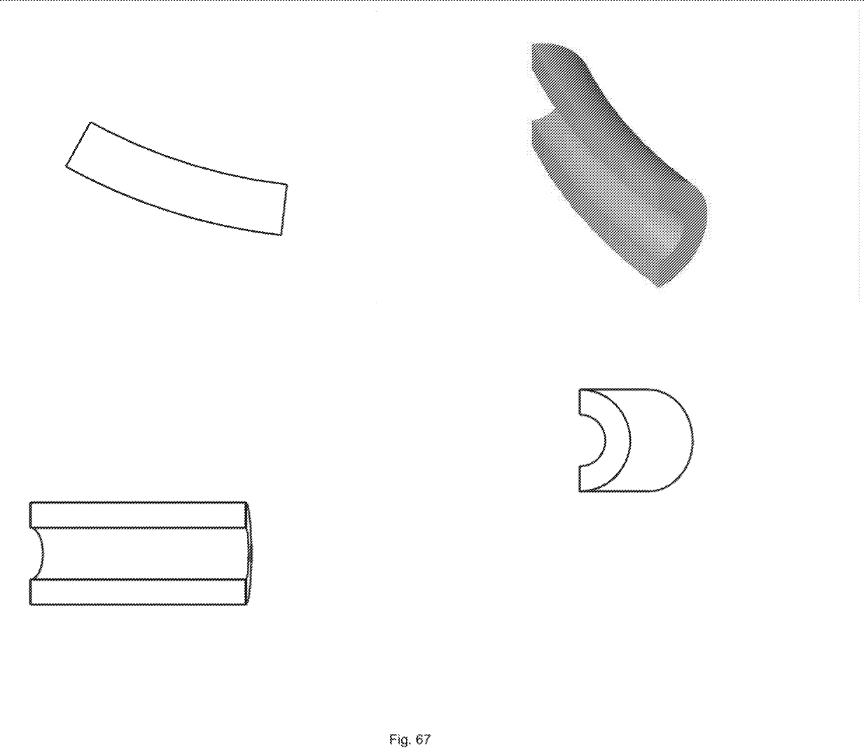

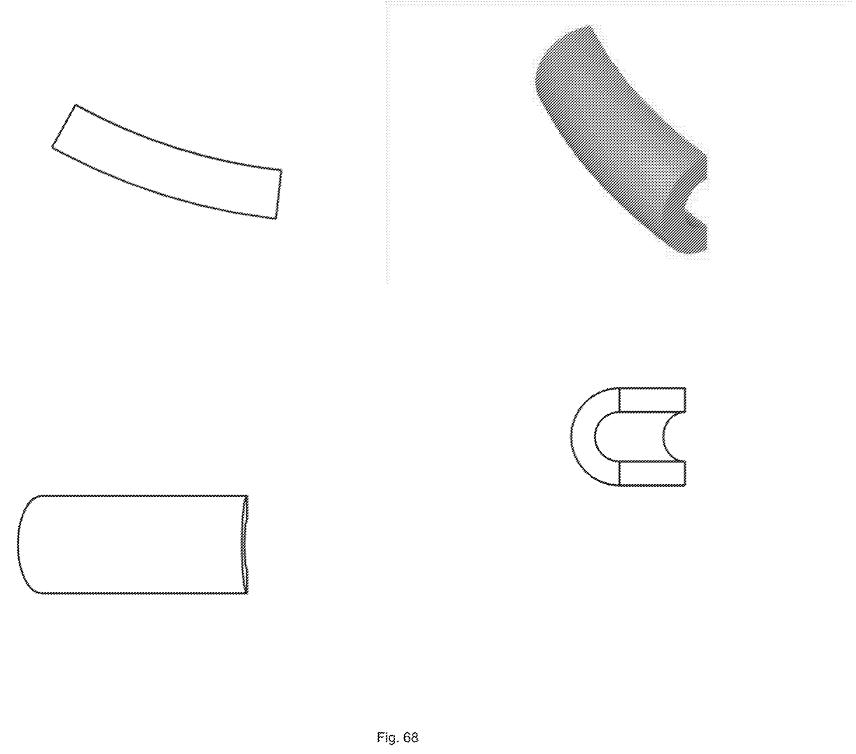

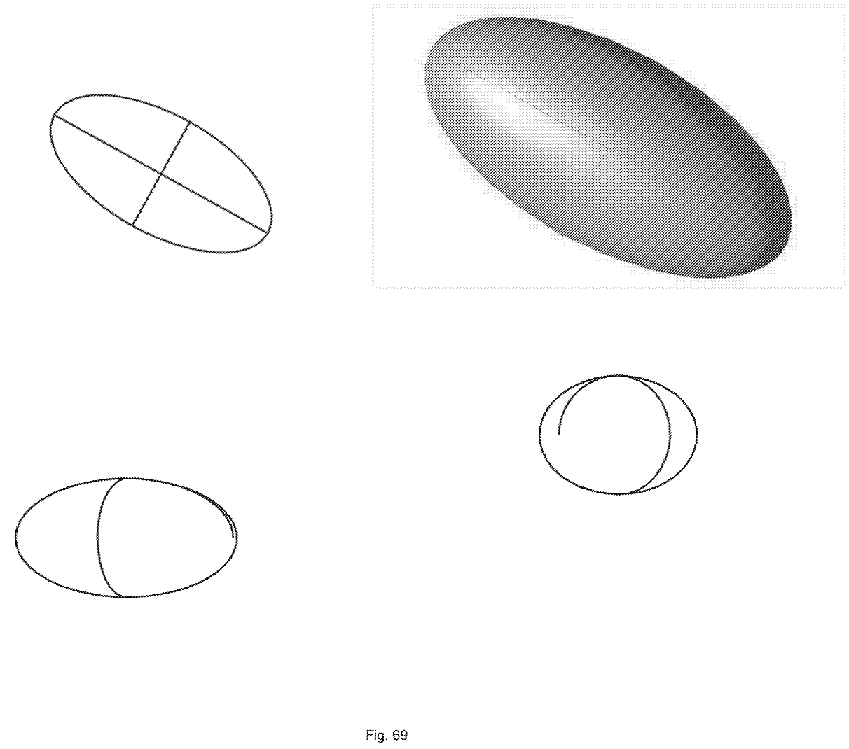

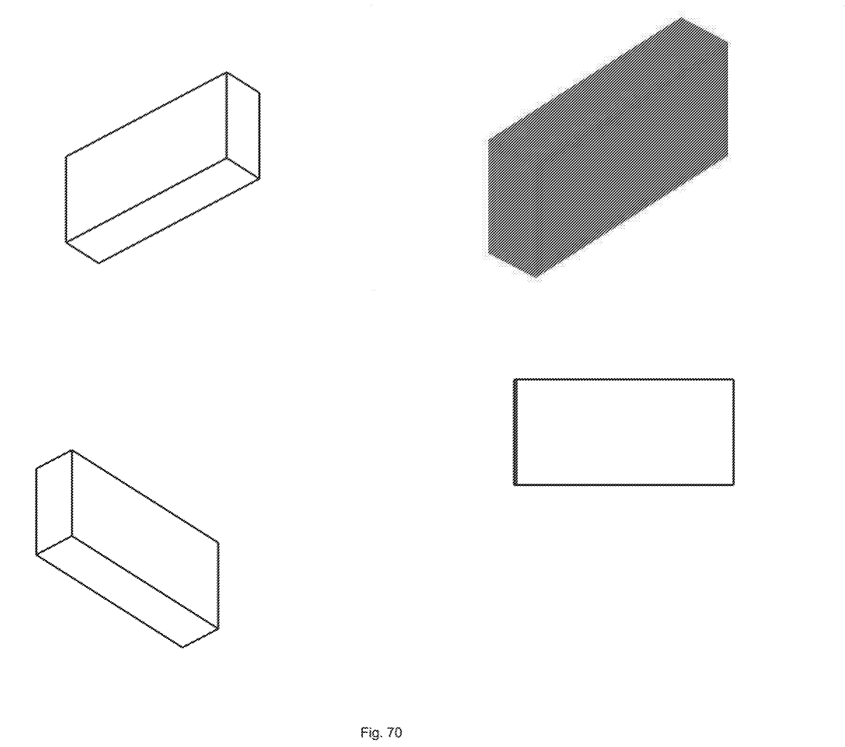

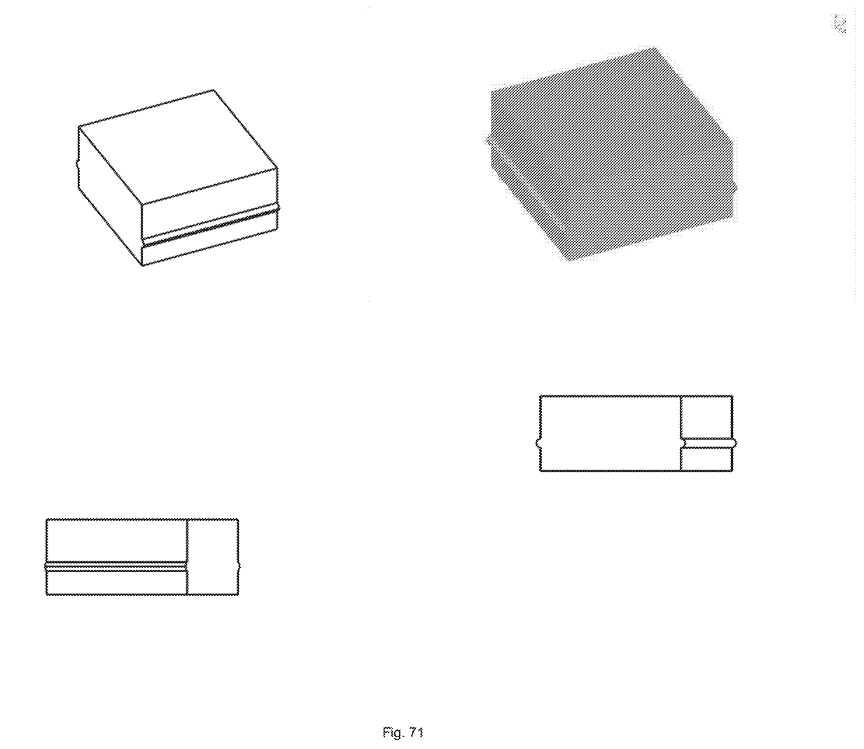

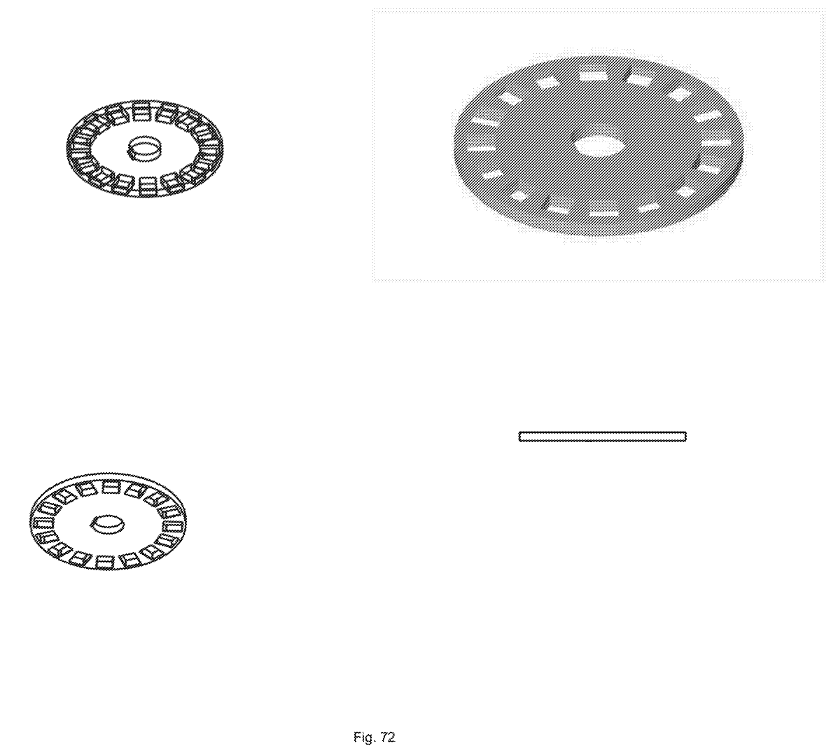

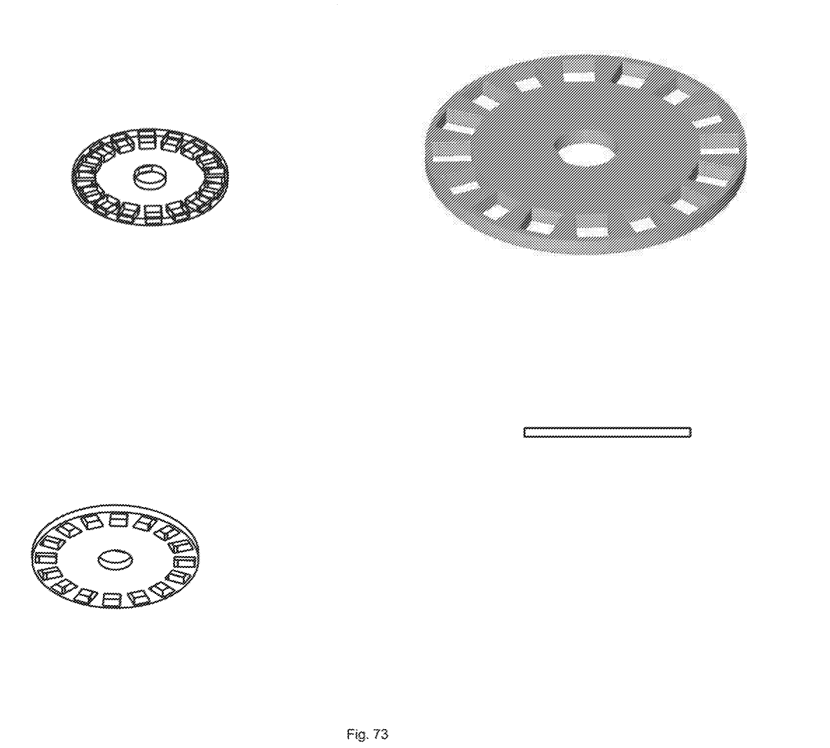

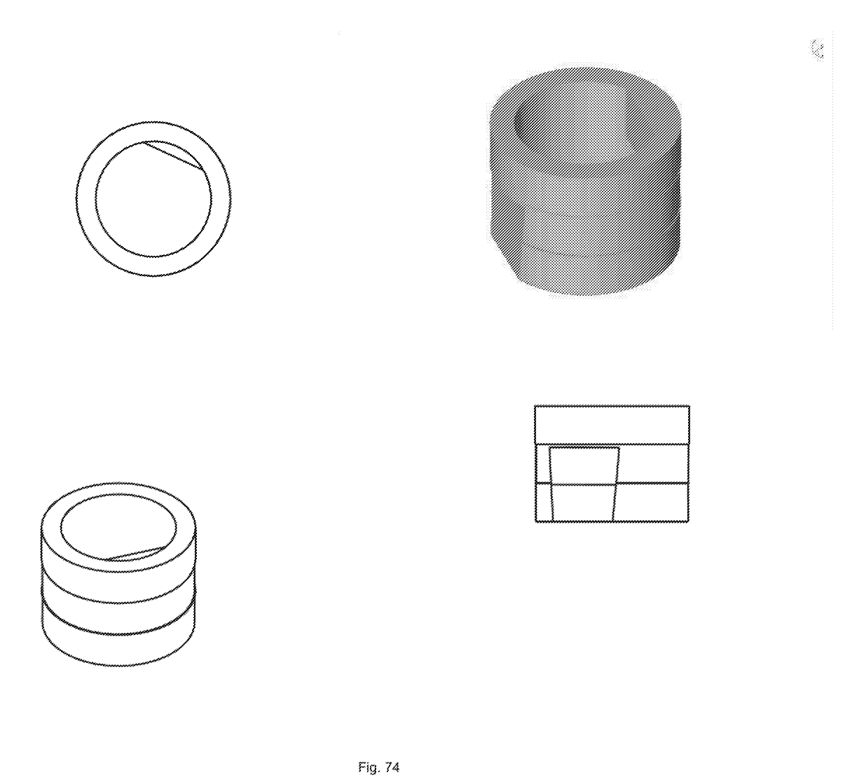

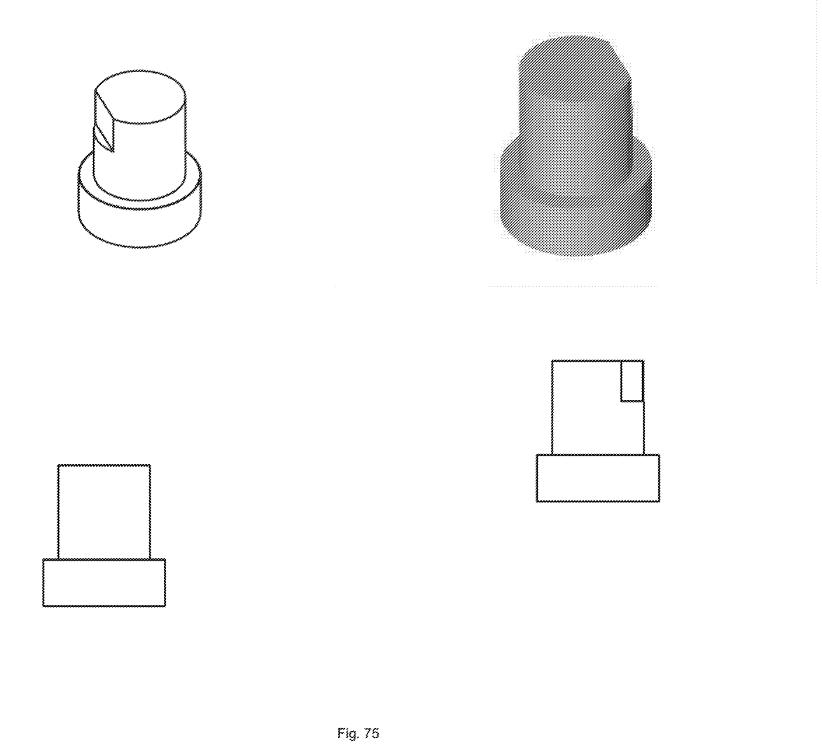

### Figures

| | |
|---|---|
| FIG. 1 | Depicts an Exploded View of the Flying-Magnet-Dynamo |
| FIG. 1-1, 1-8 | Depicts the Components of the Flying-Magnet-Dynamo |
| FIG. 2 | Depicts an Exploded View of the Vertical Windmill/ |
| | Generator |
| FIG. 3 | Depicts an Assembled Flying-Magnet-Dynamo. |
| FIG. 4 | Depicts an Assembled Vertical Windmill with four |
| | configurations of FIG. 1 |
| FIG. 5 | Depicts an Assembled Waves & Tides Generator |
| | with FIG. 1 reconfigured. |
| FIG. 6 | Depicts an Exploded View of FIG. 5 |
| FIG. 7 | Depicts an Assembled Flying-Magnet-Dynamo with |
| | mechanical interface. |
| FIG. 8 | Depicts an Exploded View of FIG. 7 |
| FIG. 9 | unused |
| FIG. 10 | unused |
| FIG. 11 | Middle-Flying-Magnet-Tube Cover |
| FIG. 12 | Universal Base |
| FIG. 13 | Central Pole Latching Pin |
| FIG. 14 | Central Pole |
| FIG. 15 | Lower Hub |
| FIG. 16 | Central Stator |
| FIG. 17 | Upper Hub |
| FIG. 18 | Upper Vane Holder |
| FIG. 19 | Upper Vane |
| FIG. 20 | Upper Flying-Magnet-Tube Cover |
| FIG. 21 | Upper Middle Vane Holder |
| FIG. 22 | Vane Adjustment Drive Gear |
| FIG. 23 | Upper Vane Drive Gear |
| FIG. 24 | Lower Vane Drive Gear |
| FIG. 25 | Special Upper Vane Drive Gear |
| FIG. 26 | Special Lower Vane Drive Gear |
| FIG. 27 | Special Lower Vane Drive Gear |
| FIG. 28 | Special Upper Adjustment Transfer Gear |
| FIG. 29 | Upper/Lower Flying-Magnet-Tube Segment |
| FIG. 30 | Flying-Magnet-Tube Connector |
| FIG. 31 | Cerfite Motor Plate (5-pole) |
| FIG. 32 | Cerfite Motor Pinion Gear Shaft |
| FIG. 33 | Lower Flying-Magnet Tube Cover |
| FIG. 34 | Lower Electronics Plate |
| FIG. 35 | Upper Electronics Plate |
| FIG. 36 | Middle Lower Rotor |
| FIG. 37 | Middle Flying Magnet Tube Segment |
| FIG. 38 | Lower Vane |
| FIG. 39 | Stator Magnet |
| FIG. 40 | Lower Vane Holder |
| FIG. 41 | Lower Rotor |
| FIG. 42 | Left Latching Arm |
| FIG. 43 | Middle Upper Rotor |
| FIG. 44 | Right Latching Arm |
| FIG. 45 | Water_Version_Outer_Case_Right_Segment |
| FIG. 46 | Water_Version_Outer_Case_Left_Segment |
| FIG. 47 | Water Vane Hub 1 |
| FIG. 48 | Water Vane |
| FIG. 49 | Bearing Rail Upper Segment_1 |
| FIG. 50 | Rail Magnet |
| FIG. 51 | Bearing Rail Lower Segment_1 |
| FIG. 52 | Inner Tube 1 Left Segment |
| FIG. 53 | Inner Tube 1 Right Segment |
| FIG. 54 | Flux Coil |
| FIG. 55 | Upper Segment Flying-Magnet-Tube |
| FIG. 56 | Flying-Magnet |
| FIG. 57 | Flying-Magnet_Tube_Connector |
| FIG. 58 | Lower Segment Flying-Magnet-Tube |
| FIG. 59 | Inter-a-Tube_Left Segment |
| FIG. 60 | Inter-a-Tube_Right Segment |
| FIG. 61 | Inner Tube 2 Left Segment |
| FIG. 62 | Inner Tube 2 Right Segment |
| FIG. 63 | Inter-b-Tube Left Segment |
| FIG. 64 | Inter-b-Tube Right Segment |
| FIG. 65 | Flying-Magnet Dynamo Mechanical Flux Coils |
| FIG. 66 | Flying-Magnet Dynamo Mechanical Flying Magnet |
| | Tube Connector |
| FIG. 67 | Flying-Magnet Dynamo Mechanical Inner Tube Segment |
| FIG. 68 | Flying-Magnet Dynamo Mechanical Outer Tube Segment |
| FIG. 69 | Flying-Magnet Dynamo Mechanical Flying-Magnet |
| FIG. 70 | Flying-Magnet Dynamo Mechanical Anti-Acceleration |
| | Foam |
| FIG. 71 | Flying-Magnet Dynamo Mechanical Rotor Magnet |
| FIG. 72 | Flying-Magnet Dynamo Mechanical Top Rotor |
| FIG. 73 | Flying-Magnet Dynamo Mechanical Bottom Rotor |
| FIG. 74 | Flying-Magnet Dynamo Mechanical Hub Insert |
| FIG. 75 | Flying-Magnet Dynamo Mechanical HUB Base |

### REFERENCE NUMBERS

| | | |
|---|---|---|
| Item No. | Description | No Used |

### DETAILED DESCRIPTION

### First Embodiment

Now referring to FIG. 1, the flying-magnet-dynamo is a device created to increase the efficiency of electrical power generation by reducing the kinetic energy required to create that electricity. Instead of turning against a large magnetic force the dynamo divides the magnetic material into portable entities (FIG. 1-2) that race around a circular hollow tube created from sections (4 & 5) surrounded with coils (FIG. 1-1) to translate the rotating magnetic force into electrical energy. A rotor (FIG. 1-8) on its upper surface contains the exact number of rectangular cavities for fixed rotor magnets (FIG. 1-7) as those magnets (FIG. 1-2) that travel inside the tube (FIG. 1-4 & FIG. 1-5), that translates the rotary physical force to a rotating magnetic force of the number of rotating fields equal to the number of magnets in the tube. The magnets racing around the tube create two additional forces, centrifugal and friction. To nullify the centrifugal force a piece of polyester foam (FIG. 1-6) is placed between the magnet on the rotor and the lateral end of travel for each rotor-magnet. As rotor speed increases the magnet, having higher density than the foam, begins pressing against that foam, which increases its resistance, as it is compressed, therefore, as speed increases the distance between the magnets on the rotor, and the respective magnet in the tube decreases thereby pulling the respective magnet in the tube with greater force, as rotor speed increases. Efficiency increasing factors have been modified by design or inclusion; first the reduction of the mass of the flying magnet, second the reduction of friction between the magnet and its guiding tube, third the remaining centrifugal force is countered by speed-related increases in magnetic force affecting the tube (FIG. 1-4 & FIG. 1-5) borne magnets. The flying-magnets are oval oblongs (FIG. 1-2) that only contact the tube (Fig.—at their apex, (1) thus reducing the friction creating surface area to the minimum. The flying-magnet is locked in this position by the field of the respective rotor-magnet. As there is one coil (FIG. 1-1) for every flying-magnet, the device produces the square number of electrical pulses per revolution. On the top rotor of embodiment one (FIG. 1-8), there are through louvers (8) to assist the exit of air within the windmill, in-fact they act as a mini-wind-turbine to also add a small amount of wind energy thrust at times. Different rotors are implemented in the three remaining positions and they all include the following, as well, as other features necessary for their application:

On all the rotors in this embodiment are always several elongated rectangular geometric cavities, each designed to accept one of the rotor-magnets, which has a rounded half-circle protrusion aligned along the longitudinal axis midway on both sides, which, in its turn, allows the magnet to snap into position then be retained. Each rotor magnet cavity has a comparable elongated half-circle cavity on both sides of the rectangular cavity that allow the magnet to slide towards the outer edge of the rotor, due to centrifugal force to the limits of movement dictated by the anti-acceleration foam (FIG. 1-6). The anti-acceleration foam (FIG. 1-6) is placed inside the initial outward position of the rotor magnet cavity against the outside wall of the cavity; the foam acts as a spring to moderately inhibit with increasing inhibition due to outward movement of the rotor-magnet then to return the rotor-magnet to its original position once centrifugal force abates.

### OPERATION

### Fig

FIG. 1-1 shows the Magnetic Flux, coils, which are orderly windings of copper wire that when traversed with magnetic lines of force orthogonally induct energy from those magnetic forces times the velocity of transition. The number of windings may vary, depending upon the particular application. The highest number of winding most likely would be in water applications where rotor speeds are lower. The minimum could be in wind applications where wind speed varies.

FIG. 1-2 shows the Flying-Magnet, as a permanent magnet of various constructions, which is encased within a ceramic ovoid, as it presents the lowest friction surface of any form. The magnet could me formed from hard ferrite material or other exotic forms to increase the energy created. A conscious choice must be made based on costs if necessary vs output energy required, the higher forms of a magnet would only slightly increase the efficiency of an already efficient design.

FIG. 1-3 shows the flying-magnet tube connector, a circular part of which has an inner circular cavity (2) equal to the outer diameter of the flying-magnet tube, it is utilized to keep the upper and low segments of the flying-magnet tube jointly and connected into a circular assembly. The connectors are just thick enough (3) to hold the four segments of the tubes together when placed properly and then secured with an adhesive.

FIG. 1-4 shows the upper flying-magnet tube segment, which utilized in multiple to form the tube upper half. The form is exactly 180 vertical degrees by 22.5 degrees horizontal for a sixteen segment configuration and 180 vertical degrees by 11.25 degrees horizontal for a thirty-two segment configuration and any other square arrangement.

FIG. 1-5 shows the lower flying-magnet tube segment, which is utilized in multiple to form the tube lower half. The form is exactly −180 vertical degrees by 22.5 degrees horizontal for as sixteen segment configuration and −180 vertical degrees by 11.25 degrees horizontal for as thirty-two segment configuration and any other square arrangement.

FIG. 1-6 shows the anti-acceleration foam created from polyester, which is a durable material utilized for its ability to be rebound to its previous form without destructive degeneration. The foam density is adjusted, depending on the weight and overall magnetic strength.

FIG. 1-7 shows the rotor magnet—the magnet, which captures the flying-magnet within the tube within its magnetic field. Once the lock is established the lock is permanent and shall not vary until the device is disassembled. There is an exactly one rotor magnet to one flying-magnet relationship, it never varies. This magnet is allowed to slide back and forth in its channel defined by two semi-round extrusions (6) on either side of the magnet that mate with slightly larger cavities within the rectangular cavity these cavities allow the magnet to be snapped into place then slide easily towards and from the rotor edge under the combined influences of centrifugal force and the anti-acceleration foam (FIG. 1-6).

FIG. 1-8 shows the rotor for the top application in this embodiment and is arranged with louvers (8) and an inner surface (7) to match the outer bearing surface of the top-hub (FIG. 2-11) matches this application, three other custom rotors are included; they are described in the following write-up.

Now referring to FIG. 2, the flying-magnet-dynamo mounted on a small-vane (FIG. 2-7) vertical windmill to create electricity for residential and commercial use; the vertical windmill is a device, which responds to unidirectional winds without the requirement for a sail or other wind direction discerning device. This allows the device to benefit from semi-up and semi-downdraft winds in addition. The flying-magnet-dynamo a device which exhibits minimal static inertia that allows this windmill to produce usable power from low-speed, winds of three to five mph. By combining the output of four dynamos at a minimal speed to provide greater than one-hundred watts of power with a top power limit of fifteen-hundred watts. The output of the four dynamos is electrically combined then passed to a re-configurable regulator the either utilizes the boost mode at low power or switching mode at high power to provide energy at standard rates to the meter electronics that interlaces the windmill to the electrical net or the customer. The small-vane windmill also allows the device to work with higher-speed winds by limiting the number of vanes open to decrease acceleration factors from the wind. Several modes are provided, when these modes are exceeded the windmill then shall shut down until lesser wind speed's resume.

The flying-magnet-dynamos are mounted one at the top, two in the middle and one at the bottom of the windmill. This arrangement allows the top energy production from moderate winds of ten to fifteen mph, that is found to be prevalent in the general winds found all over the world. The windmill provides covers (FIG. 2-1,2,25) where there are mounted the flying-magnet-tubes while protecting these tubes and other support components from direct impact by windblown elements such as sand, water, ice or smaller hail. Of course, if the destructive elements get too abusive, the windmill shall grudgingly give way. At that point, the lower cost in the performance ratio of this windmill-generator shall practically guarantee its replacement with the same.

The rotation of the windmill is achieved by forty-seven small vertical vane pairs (FIG. 2-6,20) that may individually vary from partially open to close. In this manner wind, direction is unimportant as the open vanes are available in all 360 degrees. Other nearby structures are the most probable limiting factor affecting, the direction of wind arrival to the windmill. Vane rotation is controlled between the upper vane holders (FIG. 2-4) the upper-middle vane holders (FIG. 2-4,13) which are seated in one of the circular cavities located around the periphery of the upper-middle rotor (FIG. 43) then interface with the vane adjustment gear (FIG. 2-7) of which one exists for each vane pair. Each vane adjustment gear is driven by a ratio gear (FIG. 2-10,15) which next is driven by the pinion gear of a Cerfite Stepper Motor (FIG. 2-9,16). Due to the size of the ratio gears and Cerfite motors; it was necessary to split their numbers between the two electronic plates with one special as forty-seven does not divide by two. Therefore, 23 ratio gears and Cerfite motors are spaced at regular intervals around each electronics plate with one special combination that takes two extra gears to translate the physical energy to the proper vane adjustment gear. In all, each vane adjustment gear has its own ratio gear and Cerfite motor to rotate it. The electronics plates (FIG. 2-11,17), motors, gears and associated electronics all rotate with the vanes of the windmill when wind is present and the vanes are open. The construction is light-weighted and is assisted in retaining its elevation by the lower vanes and the flying-magnets within the tubes, which are locked to the rotor magnets magnetically. All the data communications between the rotating electronic components and their static electronic counterparts occurs through to secure localized radio net established within the windmill. The electric energy created by the flying-magnets is all transported by cables, which progress down the two latching arms (FIG. 2-42,44) which in their turn also protect the wires from the moving elements carried by the wind. All the rotating electronics and motors require electrical energy; therefore, another static generator is formed between the internal stator (FIG. 2-18) which has six arms that extend to within a close distance to the rotating electronics plates. Mounted on each arm is a magnet (FIG. 2-19) that is positioned to radiate its field onto the electronic plate. Coils on each of the electronic plates (FIG. 2-11,17) receive the magnetic flux each time the coil, passes a stator magnet, in the rotation each coil creates five electric events; there are a total of fifteen of these coils that are distributed at equal distances around each electrical plate. The electrical, energy gathered is temporarily stored then the energy is regulated as required to be distributed as the operating power for the motors and electronics; super capacitors are utilized to store energy for non-wind moments when it would be necessary to open six to ten vanes around the periphery of the windmill to assume acceleration from wind presence. As the windmill commences to rotate adjustments are made to the vane geometry to utilize the available wind energy. Furthermore, the vane adjustment gears seat into the lower-middle flying-magnet-dynamo rotor (FIG. 36)

Continuing, the final rotor of the windmill (FIG. 41) contains no special features other than the circular cavities for the forty-seven lower vane holders (2-22) and the rectangular cavities where to mount the magnet and anti-acceleration foam combinations for that rotor. The rotor rests on the seat surface provided by the lower hub (FIG. 2-24) which is stabilized by the universal base (FIG. 2-25). The lower hub is held to center by the base and may slide up the periphery of the base to allow for any adjustment. The central pole (FIG. 2-21) proceeds from the universal base (FIG. 2-25) to the upper hub (FIG. 2-5) though the center of the windmill. The entire assembly is held together by the two latching arms that hook into the top hub; then provide mounting for the covers and stabilization force for the flying-magnet tube covers. Four polyester wires proceed from the upper hub (FIG. 2-5) to the lower hub FIG. 2-24) to ensure the lower hub follows any height adjustments made to the central pole are reflected into the height lower hub on the universal base neck. The height adjustment PIN (FIG. 2-23) may be inserted through any of five progressive increments through holes created by raising the central base. Continuing, the final rotor of the windmill (FIG. 41) contains no special features other than the circular cavities for the forty-seven lower vane holders (2-22) and the rectangular cavities where to mount the magnet and anti-acceleration foam combinations for that rotor. The rotor rests on the seat surface provided by the lower hub (FIG. 2-24) which is stabilized by the universal base (FIG. 2-25). The lower hub is held to center by the base and may slide up the periphery of the base to allow for any adjustment. The central pole (FIG. 2-21) proceeds from the universal base (FIG. 2-25) to the upper hub (FIG. 2-5) though the center of the windmill. The entire assembly is held together by the two latching arms that hook into the top hub; then provide mounting for the covers and stabilization force for the flying-magnet tube covers. Four polyester fish-line-wires proceed from the upper hub (FIG. 2-5) to the lower hub (FIG. 2-24) to ensure the lower hub follows any height adjustments made to the central pole are reflected into the height of the lower hub on the universal base neck. The height adjustment PIN (FIG. 2-23) may be inserted through any of six progressive increments of through holes created by raising the central pole until it's through the hole aligns with the universal base holes (FIG. 2-25).

FIG. 11 shows the middle-flying-magnet-tube_cover and is depicted in this drawing fhe middle_flying_magnet_tube cover provides support, security and mounting points for both mid-level flying magnet tubes, coils and their associated electronics.

FIG. 12 shows the Universal Mounting Base, and it is depicted in this drawing. The base is designed to accept all forms of mounting without modification. The base may be mounted on a post, next to the top of a pole, on a roof, on the valence, of a home or business. Fittings are provided to assist with all these mountings. The universal mounting base also serves as a mounting surface (11) for the lower but (FIG. 15), it in addition provides mounting for the (10) central pole (FIG. 14). Adjustment for the height of the central pole is provided six central pole adjusting holes (9). A latch pin (FIG. 13) is utilized to fix the central pole height, which when at its maximum more than five inches of the central pole remain below the fix point, insuring the central pole is as steady as its mount.

FIG. 13 shows the Central Pole latching pin, it is depicted in this drawing. The central pole latching pin must be first removed, if the user or installer wishes to change the height of the central pole. The pin must then be re-inserted when the pole setting cavity reaches the compatible position on the universal base where needed next to utilize the pin to secure the central pole.

FIG. 14 shows the Central Pole, which is depicted in this drawing. The central pole mounts Central Stator (FIG. 16) and the upper Hub (FIG. 17). In the case of the upper hub, special geometrical cavities (13) molded into the top of the pole ensure the orientation of the upper huh then lock that huh into position. The height of the Central Pole may be adjusted upward for clearance or mounting; the central pole contains one adjustment through the hole (12) into which the latching pin of (FIG. 13) must be inserted through the base hole with the pole hole just adjacent to lock the central pole in place.

FIG. 15 shows the Lower-Hub, and it is depicted in this drawing. The hub contains a central cavity (15) that either sits at the bottom of the universal base turret. The hub may slide up the turret if the central pole is raised. On the outer ring of the lower huh, a surface compatible with the lower rotor (FIG. 41) which rotates upon this outer surface (14).

FIG. 16 shows the Central Stator, and it is depicted in this drawing. The Central Stator is attached to the Central Pole (FIG. 14). Six arms each holding a magnet reach out and nearly touch the electronic plates. Each magnet is fixed with a pole piece which bubbles out the magnetic field further than normal. This is to ensure the coils on the electronic plates are fully saturated with flux, to enhance the energy transfer.

FIG. 17 shows the Upper Hub, as it is depicted in this drawing. The construction ensures a great connection to the central pole (FIG. 14) (17), while providing a mating surface for the latching arms (16), (FIG. 42, 44).

FIG. 18 shows the Upper Vane Holder, as it is depicted in this drawing. The upper vane holder accepts the upper tip (20) of an upper vane (FIG. 19). It has a slip-fit cavity (18) which holds the vane tip secure. An adhesive is included to ensure the attachment remain secure. The upper vane holder has a dual diameter (19) to match the cavity in the upper rotor (1-8) which prevents the downward movement of the vane holder. This arrangement secures the upper vane tip allowing it to rotate on the axis of the upper vane holder. It, also removes the weight of the upper vane from the middle assembly.

FIG. 19 shows the Upper Vane, as it is depicted in this drawing. The upper vane is a wind-catching device when angled and a wind rebuffing device when closed. Constructed of semi-ridged material the vane is allowed minimum flexing during operation allowing it to buffer snippets of variances in wind pressure. As during rotation, each vane is exposed for only milliseconds to wind pressure, this ensures a long service life for each vane. The vane is secured by two slip-fit extrusion (20) and the top and (21) at the bottom, that lock the vane into sockets that may rotate to set the vanes angle of operation.

FIG. 20 shows the upper flying-magnet tube covers, as it is depicted in this drawing. The upper cover mounts the flying-magnet-tube b securing each tube connector. The cover featuring rotund projections (22) angled properly to support every tube connector with a secure socket. The cover protects the flying-magnet tube, coils, components and connections from direct impact by windblown elements. Within reason of course, a sandstorm would eventually destroy the entire windmill if its effects lasted for a few days.

FIG. 21 shows the upper-middle vane holder, as it is depicted in this drawing. The upper-middle vane holder is designed to fit the cavity of the middle-upper rotor (FIG. 43) which contains the cavities lot the vane holder around its periphery. Again, the dual diameter (24) ensures retention of the part while not allowing compaction or movement downward. The upper portion of the upper-middle vane holder (23) accepts the lower tip of the upper vane (FIG. 19) which is similar to the upper tip of the upper vane but at a less aggressive angle. The lower portion of the upper-middle vane holder includes a cavity to accept the top extrusion (23) of the vane adjustment gear (FIG. 22).

FIG. 22 the vane adjustment gear, is depicted in this drawing. The vane adjustment gear is the main rotate element of the vanes. The upper extrusion (25) matches the lower cavity in the upper-middle vane holder. The gear portion (26) directly accepts torque from the ratio gear for that vane. The lower portion of the vane adjustment gear (27) matches with the cavity on the periphery of the lower-middle rotor. The vane adjustment gear also retains a cavity on it lower portion to accept the upper tip extrusion of the lower vane (FIG. 38). The shoulder at the top of the gear portion also provides support for the upper electronics plate. The bottom of the vane adjustment gear in addition supports the lower electronic plate (28). The gear portion of the vane adjustment gear (26) is elongated to receive torque from the upper and lower drive gears equally (FIG. 23, 24).

FIG. 23 shows the upper vane drive (ratio) gear, as it is depicted in this drawing. The upper vane drive gear is a part of the set of gears mounted close to the bottom of the upper electronic plate; this gears contact the vane adjustment gear at the upper portion. The input of the drive gear is the pinion gear of the Cerfite motor (FIG. 32) adjacent to the gear. There is a total of 22 upper ratio gears within this embodiment.

FIG. 24 shows the lower vane drive (ratio) gear, as it is depicted in this drawing. The lower vane drive gear is a part of the set of gears mounted close to the top of the lower electronic plate; this gears contact the vane adjustment gear at the lower portion. The input of the drive gear is the pinion gear of the Cerfite motor (FIG. 32) adjacent to the gear. There is a total of 22 lower ratio gears within this embodiment.

FIG. 25 shows the special upper vane drive (ratio) gear, which is depicted in this drawing. The special upper vane drive gear is specifically to drive the odd or forty-seventh vane adjustment gear. One interim non-ratio gear (FIG. 28) to transfer the torque from the Cerfite motor adjacent to the transfer gears.

FIG. 26 shows the special upper adjustment gear, which is depicted in this drawing, fhe special upper adjustment gear is designed at one of a two gear pair to alter the physical location of torque energy then transfer this energy around a slight corner.

FIG. 27 shows the special lower vane drive gear, which is depicted in this drawing. The special lower vane drive gear is the actual gear that drives the vane adjustment gear from a space between two other drive gears on the same level. This drive gear is actually mid-way between the upper and lower electronic plates. This gear drives the forty-sixth vane drive gear.

FIG. 28 shows the special torque transfer gear which interfaces the special upper vane drive gear, from at location where it as possible to mount the special drive Cerfite motor as mounting the motor in the usual offset position is impossible. Tris gear utilizes the special lower gear (FIG. 29) shaft as its axis while extrusion (32) insures upward position while the lower extrusion (31) rides, on the top of the special lower vane drive gear (FIG. 27).

FIG. 29 shows the middle flying-magnet-tube segment. This segment is moderately greater in are due to the somewhat greater circumference of the middle two dynamo rings to allow both rings to be mounted on the same cover and to clear rotating components.

FIG. 30 shows the flying magnet tube connector which serves to join four segments of the upper, middle and lower tubes. The inner cavity (33) diameter is identical to the outer diameter of the tube to provide a secure tit while the outer (34) diameter is utilized to support the entire assembly by mounting protrusions from the covers (36).

FIG. 31 shows the Cerfite motor rotor which is formed from a ceramic disk then embedded with soft-ferrite material in five poles distributed evenly around the periphery of the disk. The center cavity contains a semi-circular cavity which ensures torque is transferred to the pinion gear (FIG. 32) shaft.

FIG. 32 shows the Cerfite motor pinion gear, as it is depicted in this drawing. The pinion gear, is set at the proper teeth to match the ratio gears, at the standard height, so that the same motor may be utilized in upper or lower positions without any adjustment.

FIG. 33 shows the lower flying-magnet-tube cover. The lower flying-magnet-tube cover provides the same type of tube connector (37) which holds the tube secure, while to cover provides protection from the elements direct impact. Furthermore, mounted inside the cover shall be the base electronics package, which includes meter electronics and software, as well as base radio communications with the windmill components.

FIG. 34 shows the lower electronics plate, as it is depicted in this drawing. The lower electronics plate contains the mounting cavities for all twenty-two-lower and twenty-three upper ratio gears. (In addition it provides cavities and associated electronics to mount and control twenty-three Cerfite motors.

FIG. 35 shows the upper electronic plate, which is depicted in this drawing. The upper electronic plate contains the mounting cavities for twenty-two lower and twenty-three upper ratio gears; Furthermore, it provides cavities and associated electronics to mount and control twenty-four Cerfite motors.

FIG. 36 shows the lower-middle rotor, which is depicted in this drawing. The lower-middle rotor contains forty-seven cavities to support the lower portion of the vane adjustment gears which provide the lower vanes with a secure mounting cavity and rotation energy identical to the upper rotors. Furthermore, the lower-middle rotor provides the cavities for rotor-magnet assemblies.

FIG. 37 shows the middle-flying-magnet tube segment, which is depicted in this drawing. The middle-flying-magnet tube segment is unique among the fact that due to the slightly larger circumference of the windmill at the middle requires a tube segment of slightly fewer arcs per segment than the upper and lower flying-magnet-tube segments. The number of segments remained the same and upper, and the lower-middle segments are identical.

FIG. 38 shows the lower vane, as it is depicted in this drawing. The lower vanes are identical to the upper vanes except that the lower vane is mounted in the inverted state in the forty-seven lower vane positions.

FIG. 39 shows the stator-magnet, as it is depicted in this drawing. The stator-magnet is of rectangular construction with an integral pole piece the enhances the magnetic-field range away from the stator towards the outer edge components. This field is sensed then amplified to become the power for the electronics and electromechanical.

FIG. 40 shows the low vane holder, which is depicted in this drawing. The lower vane holder is compatible with the cavities located around the periphery of the lower rotor (FIG. 41). These holders provide a secure fit for the tab at the end of the lower vane (38). The holder allows rotation on its vertical center for the vane. Therefore, this affects the completing the geometry for vane rotation. The holder has a dual-diameter construction to disallow downward movement (39).

FIG. 41 shows the lower-rotor, as it is depicted in this drawing. The lower-rotor is the last rotating item in the windmill. The rotor provides compatible cavities (40) for the forty-seven lower vane holders (FIG. 40) and the lower sixteen lower magnetic assemblies that constitute the lower flying-magnet-dynamo'dynamo's rotor-bound components. The rotor contains a center cavity compatible with the lower hub (FIG. 15).

FIG. 42 shows the left latching arm, which is depicted in this drawing. The left latching arm hooks into the upper hub the provides the mounting support and security for the three flying-magnet-tube covers (FIG. 11,20,33) it also serves as a guide-way for wires proceeding down to the lower cover.

FIG. 43 shows the middle-upper rotor, as it is depicted in this drawing. The middle upper rotor contains the forty-seven cavities compatible the dual-diameter construction of the upper-middle vane holder (FIG. 21); furthermore, the through cavity supports the extruded tab on the vane adjustment gear (FIG. 22 to mate with the bottom of the upper-middle vane holder (FIG. 21). In addition rectangular cavities are provided compatible with the rotor-magnet assemblies.

FIG. 44 shows the right latching arm, as it is depicted in this drawing. The right latching arm is not unique but mirrors exactly the left latching arm.

### Second Embodiment

Now referring to FIG. 6, The flying-magnet-dynamo mounted in a water generating environment in this application embodiment the reconfiguration of the dynamo to act in this dynamic situation where the low static inertia of the dynamo shall allow the device to utilize high-angle blades that may follow every move of the water. This coupled with the design utilizing a water-bearing system presents a long life instrument that shall extract every erg of energy it is presented. It is necessary to cheaply and securely protect the electronic portion of the instrument from water, and this is accomplished by a simple design that takes everything into account. The instrument is described in the following: The outer shell (1) & (2) provide complete containment of a two-dynamo system. The hub (3) provides a center turning radius, but does not bear against anything it forms as a focus instrument for the five blades. The blades ride on a two-piece rail (5) & (7) that also contains the rotor-magnets now renamed as rail magnets (6). Due to the slow speed of water there is not the requirement to account for centrifugal acceleration as it is negligible. The first internal shell (8) & (9) mounts and confines all the components (3 to 7) within, while items (10 through 14) exist on the outside of the shell and directly inline with the internal components. Sections (15 & 16) form an internal spacer and guide to the water, where the second arrangement just as the first is repeated in items (17 through 28); the final internal shell; segments (29 and 30) complete the assembly, therein there is a water driven dual-dynamo generating system that shall work equally with water running either direction. Therefore, the construction allows easy access for water while protecting the electronics and other moving parts without any mechanical link. The devices are light-weight and may be easily placed in streams, or inlets where tides and waves abound.

FIG. 45 shows the outer case right segment, as it is depicted in this drawing. The outer case right segment forms one-half of the circular casing. At each end at the terminus of the arc a small tab (40) is provided to allow the right and left (FIG. 46) segments to be bolted together securely.

FIG. 46 shows the outer case left segment, as it is depicted in this drawing. The outer case left segment forms the exact half of the shell with the right half (FIG. 45). One each half there are cavities (41) to assist in locking the flying-magnet-dynamo-tube connectors (FIG. 57), one cavity exists one-half of the tube connectors in both cases haves thereby securing all the tube connectors in place.

FIG. 47 shows the water vane huh, which is depicted in this drawing. The water vane hub serves as a central socket for the tips of the water vanes. When all vanes are in place the hub is securely held situated properly, it also diverts the water from intersecting, the blade tips which could set up a vortex action which would denigrate the efficiency of the water turbine.

FIG. 48 shows the water vane, as it is depicted in this drawing. The water vane an equidistant design that is practical to work in either direction, the vane's outer edges are fixed to rail from extrusions (FIG. 49 while the inner tip is secured to the huh (FIG. 47).

FIG. 49. The bearing rail upper segment is depicted in this drawing. The bearing rail upper segment has extrusions (42) that intersect the water vane outer edges. The rail also forms one-half of as water-bearing which is held equidistant by the magnets in the flying-magnet-dynamo tube (FIG. 56) interacting with the corresponding rail magnets (FIG. 50) contained between the two halves of the rail.

FIG. 50. The rail magnet is depicted in this drawing. The rail magnet performs the exact equivalent of the rotor-magnet in other embodiments of the flying magnet dynamo. As there is not any great speed involved there is not any require not for magnet movement and an anti-acceleration foam.

FIG. 51. The hearing-rail lower segment is depicted in this drawing. The hearing rail lower segment is just the completion of the tube. There are no remarkable features.

FIG. 52. The inner tube one left segment is depicted in this drawing. The inner tune one left segment forms a mounting point for all the inside items the bearing rail, water vanes and the cavities for the outside tube connectors (43) to which the other components of the dynamo-generator are attached.

FIG. 53. The inner tube one right segment is depicted in this drawing. The inner tube one right segment mirrors exactly the left segment. There are no remarkable features.

FIG. 54. The flux coil is depicted in this drawing. The flux coil is an orderly wound coil of copper wire that intercepts magnetic flux from the flying tube magnets as they pass through the flux coil.

FIG. 55. The upper segment flying-magnet tube is depicted in this drawing. The upper segment of the flying magnet tube forms one-half of the hollow circular tube constructed of upper and lower (FIG. 58) segments. The segments are connected and held in place by the tube connectors (FIG. 57) to form an entire hollow circle.

FIG. 56. The flying magnet is depicted in this drawing. The flying magnet is an ovoid entity filled with hard-ferrite material. The material and form of the flying magnet must be selected to minimize weight and friction.

FIG. 57. The flying-magnet tube connector is depicted in this drawing. The flying-magnet tube connector provides the gathering surface for the tubes adequate to secure the tubes (44) situated properly, in addition, the connectors are held securely situated properly by the construction of the fully through cavities in the inner tube sections (FIG. 52, 53, 61, 62) and completed by the partially through cavities in the outer case segments (FIG. 45, 46).

FIG. 58. The lower segment of the flying-magnet tube is depicted in this drawing. The lower segment of the flying magnet tube is the exact mirror of the upper segment. There are no remarkable features.

FIG. 59. The inter-a-tube tube left segment is depicted in this drawing. The left segment of the inter-a-tube is unremarkable; it is utilized to keep the water path continuous.

FIG. 60. The inter-a-tube right segment is depicted in this drawing. The right segment of the inter-a-tube is an exact mirror of the left segment, there are no remarkable features.

FIG. 61. The inner tube two lea segment is depicted in this drawing. The inner tube two left segment forms one-hail of the containment for the rail bearing, and water-vane components of the second generations station; it also provides through cavity mourning for the flying-magnet tube connectors (FIG. 57).

FIG. 42. The inner tube two right segment is depicted in this drawing. The inner tube two right segment is an exact mirror of the left segment, there are no more remarkable features.

FIG. 63. The inter-b-tube left segment is depicted in this drawing. The inter-b-tube left segment is simply a guide to promote laminar water flow into or out of the generator. There are no remarkable features.

FIG. 64. The inter-b-tube right segment is depicted in this drawing. The inter-h-tube right segment is an exact mirror of the left segment, there are no remarkable features.

### Third Embodiment

Now referring to FIG. 8, the flying magnet dynamo in a mechanically driven environment. In this embodiment application, the low static inertia of the flying-magnet reduces the wasted energy that made it necessary to have such large engines to generate power. The mechanical flying-magnet-dynamo is shown without an enclosure, which is often to be incorporated within the enclosure with its mechanical driver whatever it may be. The mechanical dynamo is described in the following: The flux coils (1) are quintessential to the concept; the coils are wound around the combined tube segment halves (3 & 4). The flying-magnets (5) are then placed within the tube assembly spaced one at the midpoint of each coil. The entire coil, tube and magnet conflagration is secured by the tube connectors (2). This whole assembly floats inline with the rotor assembly which consists of two rotors (8 & 9) that are equipped with cavities to accept the magnets (7) and anti-acceleration foam (6); the entire rotor assembly is driven by the two-piece huh base which may be coupled to a mechanical power source in various ways.

FIG. 65. The flux coil is depicted in this drawing. The flux coils are orderly wound coils of copper wire essential to the effect of generating electrical energy from magnets that pass trough them. The effect is often called the Faraday effect.

FIG. 66. The flying-magnet tube connector is depicted in this drawing. The flying-magnet tube connector provides a surface to hold all the tube segments secure. The connectors themselves are often utilized as a connect point to supporting structure or enclosure. The connectors are farther secured in place by the coils of wire (FIG. 65) between them.

FIG. 67. The flying-magnet tube inner segment is depicted in this drawing. The flying magnet tube inner segment forms one-half of the hollow flying-magnet tube. There are no remarkable features of this device.

FIG. 68. The flying-magnet tube outer segment is depicted in this drawing. The flying-magnet tube outer segment is the opposite to the inner tube segment (FIG. 67) together they form a complete segment of a hollow tube; the parts are not interchangeable.

FIG. 69. The flying-magnet is depicted in this drawing. The flying magnet an ovoid which is filled with hard-ferrite material then magnetized along its longitudinal axis. More exotic magnetic material may be substituted for the ferrite with some increase in efficiency as the material most likely shall be heavier thus requiring slightly more power to fly.

FIG. 70. The anti-acceleration foam is depicted in this drawing. The anti-acceleration foam is a polyester construction that is utilized to inhibit outward travel of the rotor magnet with increasing resistance due to compaction of the material.

FIG. 71. The rotor magnet is depicted in this drawing. The rotor magnet is allowed two different heights the first twice as tall as the other. For areas that have magnetic interference the larger magnet is necessary. All the rotor magnets have the same construction with the small rounded extrusion to allow snap in place the sliding along the longitudinal axis.

FIG. 72. The top rotor is depicted in this drawing. The top rotor is one-half the rotor of the mechanical flying-magnet-dynamo. The rotor contains rectangular cavities to accept a rectangular magnet (FIG. 70) and its associated anti-acceleration foam (FIG. 69).

FIG. 73. The bottom rotor is depicted in this drawing. The bottom rotor becomes only effective when the larger rotor magnets are in use, at that time, the rounded extrusion of the magnet is held between the two plates while a larger foam is also utilized with the larger magnet.

FIG. 74. The hub insert is depicted in this drawing. The rotors and hubs are keyed so that they may only assemble one way any other combination shall not align properly. This key arrangement extends from the to rotor (FIG. 72) to the Hub Base (FIG. 75).

FIG. 75. The huh base is depicted in this drawing. The huh base accepts any number of means to connect rotary power. The rotary power is translated upward to the rotors.

### CONCLUSION

### Ramification<Scope

The flying-magnet-Dynamo is as device which increases the efficiency electric energy generation, mainly by the reduction of the amount of energy required to produce a watt of electrical power. In total, a gain of fifteen to twenty percent efficiency is within the realm of this device. All factors are easily altered to match a particular application; the number of magnets involves, the size of the coils and the size of the magnets are all adjustable to meet and end application. All variations and modifications are claimed in this application within the scope of this application and may be enjoined up without departing from the spirit of the device.

The invention claimed:

1. An electric generator (dynamo) a short cylinder sliding on a central axis with components to affect the creation of electric energy, from wind, water or mechanical energy comprising:
a. a permanent magnet with side half-rounded extrusion's midway that may slide tangent to the axis with progress mitigated by a polyester based foam block, which varies the density under compression to increase resistance in a linear curve, as employed in wind and mechanical energy, but, not in water;
b. an oblong magnet that is surrounded by friction reducing material then captured within the magnetic-field of the magnet described in claim a;
c. a circular tube created by adding successive arced sections that are secured by said connectors described in claim d;
d. a connector formed, as a circular or semi-circular object with a circular cavity in the center what is of the same diameter as the tube sections defined in claim c; when properly combined then placed together end on end, securing these sections in place by confining the sections within the core cavity, which is wide enough to contact all four sections well enough to secure them;
e. a. coil of copper wire, surrounding the tubular sections, as defined in claim c, that are held in place by connectors described in claim d, then surrounded by well-ordered loops of copper wire connected to low ESR capacitors to affect the resolution to capture electric pulses;
f. mechanical powered operation, utilizing a hub and rotor that can allow many kinds of magnetic material and anti-acceleration foam choices.

2. A wind embodiment, as defined in claim one, that is formed in combination with a small-vane vertical axis windmill with individually adjustable vanes and
a. four distinct, flying-magnet dynamo rotors;
b. a universal base that allows the device to be mounted almost anywhere;
c. a Cerfite stepper motor that is implemented by a material enclosed soft or hard ferrite pole piece placed in a triad coil five pole or other combinations of the same nature, utilizing primed circuit mounted coils and electronics to activate the motor;
d. a many arm stator mounted on the axis pole to wireless charge the rotating components with energy via coils on the rotating components;
e. a universal hub that is a mounting point for the top rotor and a mounting pace for the latching arms;
f. embedded-radio micro processors of Silabs in a vertical windmill with wireless controls of rotating and static controls and transferring power;
g. latching arms defined in claim e that provide secure covers and mounting points for tube connectors defined in claim one;
h. a combination gear and vane holder, as defined in the vane adjustment gear;
i. a vane holder that provides secure mounting for a vane, while allowing, free rotation on its axis.

3. A water embodiment, as defined in claim one, implemented by implementing a tubular construction that protects the tubes and electronics from water, while allowing free rotation of water-borne Components, and
a. as confining structure that locks and supports all components in place and may be mounted almost anywhere;
b. a water-beating rail that includes the rotor magnets, which provides free rotation of the vanes and hubs of a water implemented electric power generator.
